(19) United States
(12) Patent Application Publication
(10) Pub. No.: US 2014/0144334 A1
(43) Pub. Date: May 29, 2014

(54) OVEN AND APPARATUS FOR HOLDING A FOOD ITEM IN AN OVEN CAVITY

(71) Applicant: Duke Manufacturing Co., St. Louis, MO (US)

(72) Inventors: Robert J. Reese, Edwardsville, IL (US); Christopher Seay Green, Affton, MO (US); Ralph Lee Macy, St. Peters, MO (US); Steven M. Shei, Fort Wayne, IN (US); Philip Tiberio, St. Charles, MO (US)

(73) Assignee: Duke Manufacturing Co., St. Louis, MO (US)

(21) Appl. No.: 14/167,018

(22) Filed: Jan. 29, 2014

Related U.S. Application Data
(63) Continuation of application No. PCT/US2012/048861, filed on Jul. 30, 2012.
(60) Provisional application No. 61/513,424, filed on Jul. 29, 2011.

(51) Int. Cl. A47J 39/00; A47J 36/24

(52) U.S. Cl. CPC A47J 39/003; A47J 39/006; A47J 36/2483
USPC 99/483; 219/393; 219/400

(57) ABSTRACT

A system includes an oven and an apparatus configured for holding at least one food item and being inserted in a cavity of the oven through an open end of the cavity. A baffle provided on the oven or apparatus has a height extending between the peripheral rim and an upper wall of the oven cavity for restricting flow of gas out of the cavity from the apparatus. Various forms of baffles may be used. The baffles may have adjustable, interchangeable, fixed position, or other configurations.

### CROSS-REFERENCE TO RELATED APPLICATIONS

This application is a continuation of PCT Patent Application No. PCT/US2012/048861, filed Jul. 30, 2012, which claims priority to U.S. Provisional Patent Application No. 61/513,424, filed Jul. 29, 2011, both of which are hereby incorporated by reference in their entirety.

### FIELD OF THE INVENTION

The present invention generally relates to food service equipment and, more particularly, to ovens and food containers for cooking food or for holding cooked foods at conditions suitable for serving.

### BACKGROUND OF THE INVENTION

Restaurants such as “fast-food” restaurants that specialize in serving cooked food rapidly do not have the capacity to quickly cook large quantities of food on demand. These restaurants typically have high demands during traditional meal times such as lunch and dinner times. The restaurants usually prepare cooked food in advance of a meal time and keep that food warm in a holding oven. Then, during a meal time when the demand is greatest, the restaurant will use the already cooked food.

### SUMMARY

In a first aspect, the present invention is directed to apparatus configured for holding at least one food item and being inserted in a cavity of an oven. The oven cavity is bounded by at least a bottom wall, opposite side walls, and an upper wall. The cavity has opposite first and second ends at least one of which is open for receiving the apparatus in the oven cavity. The apparatus includes a food container having a bottom wall, opposite side walls, opposite first and second end walls, a peripheral rim, and an open top. The food container is sized and shaped for receiving the at least one food item. The apparatus also includes a baffle attached to the food container. The baffle is positioned adjacent to one of the first and second end walls and extends above the peripheral rim of the food container for restricting gas flow out of the open end of the oven cavity along a flow path between the peripheral rim and the upper wall of the oven cavity when the food container is in the oven cavity.

In another aspect, the present invention is directed to an oven for holding at least one food item. The oven includes an oven cavity sized and shaped for holding the at least one food item. The cavity has a bottom bounded by a bottom wall, opposite sides bounded by side walls, and a top bounded by an upper wall, the cavity having opposite first and second ends at least one of which is open. A baffle is positioned adjacent the top of the cavity at the open end of the cavity. The baffle extends downward from the upper wall to a position below the upper wall for restricting gas flow out of the open end of the oven cavity at the top of the oven cavity. The baffle includes a gas flow opening for permitting gas to flow from the top of the oven cavity through the gas flow opening to outside the oven cavity.

In yet another aspect, the present invention is directed to a system for holding at least one food item. The system includes an oven including an oven cavity. The cavity has a bottom bounded by a bottom wall, opposite sides bounded by side walls, and a top bounded by an upper wall. The cavity has opposite first and second ends at least one of which is open. The system also includes a food container having a bottom wall, opposite side walls, opposite first and second end walls, a peripheral rim, and an open top. The food container is sized and shaped for receiving the at least one food item. The system also includes a kit including first and second baffles each adapted for releasable connection to at least one of the oven and the food container for restricting gas flow out of the oven cavity. The baffles when connected to the at least one of the oven and food container being positioned for restricting gas from flowing from the oven cavity through a gap between the peripheral rim of the food container and the upper wall of the oven cavity to outside the oven cavity. The second baffle is configured for permitting more gas flow through the gap than the first baffle. The baffles are selectively connectable to the at least one of the oven and the food container for restricting gas flow through the gap according to the configuration of the selected baffle.

### BRIEF DESCRIPTION OF THE DRAWINGS

FIG. 1 is a perspective of a system of the present invention including an oven and two food containers for holding food items in cavities of the oven;

FIG. 2 is a perspective of the oven of FIG. 1;

FIG. 3 is a rear elevation of the oven;

FIG. 4 is a perspective of one of the food containers shown in FIG. 1;

FIG. 5 is a section of the food container taken along the length of the food container;

FIG. 6 is a perspective of the food container in which a rack of the container is shown elevated from a tray of the container;

FIG. 7 is a perspective of the rack;

FIG. 8 is a section of the food container taken along the width of the food container;

FIG. 9 is a side elevation of the food container;

FIG. 10 is an enlarged side elevation of a front end of the food container;

FIG. 11 is a front end elevation of the food container;

FIG. 12 is a front elevation of the oven, the two food containers being shown positioned in respective oven cavities;

FIG. 13 is a perspective of another embodiment of a rack of the present invention;

FIG. 14 is a front elevation of an oven having food containers in respective oven cavities, the food containers each including a rack as shown in FIG. 13;

FIG. 15 is a front elevation similar to FIG. 14 but showing baffles on the racks in different positions;

FIG. 16 is a section taken along a length of a lower portion of the oven of FIG. 15 including the lower oven cavity and the food container in the oven cavity;

FIG. 17 is a perspective of a food container of another embodiment of the present invention;

FIG. 18 is a front elevation of an oven having two food containers in respective oven cavities, the food container in the upper oven cavity including the rack of FIG. 17, and the food container in the lower oven cavity including a rack similar to the rack of FIG. 17 but having a shorter baffle member;

FIG. 19 is a section taken along the length of a lower portion of the oven of FIG. 18 including the lower oven cavity and the food container in the cavity;

FIG. 20 is a front elevation of a bottom portion of an oven having another embodiment of a food container according to the present invention positioned in an oven cavity;

FIG. 21 is a front elevation of a bottom portion of an oven having another embodiment of a food container according to the present invention positioned in an oven cavity;

FIG. 22 is a section taken along the length of the bottom portion of the oven of FIG. 21 including the lower oven cavity and the food container in the oven cavity;

FIG. 23 is a front elevation of a bottom portion of an oven having another embodiment of a food container according to the present invention positioned in an oven cavity;

FIG. 24 is a section taken along the length of the bottom portion of the oven of FIG. 23;

FIG. 25 is a front elevation of a bottom portion of an oven having another embodiment of a food container according to the present invention positioned in an oven cavity;

FIG. 26 is a section taken along the length of the bottom portion of the oven of FIG. 25 including the oven cavity and the food container in the oven cavity;

FIG. 27 is a front elevation of an oven having additional embodiments of food containers according to the present invention in respective upper and lower oven cavities;

FIG. 28 is a section of a bottom portion of the oven including the bottom oven cavity and the food container in the oven cavity;

FIG. 29 is a front elevation of a bottom portion of an oven having another embodiment of a food container according to the present invention positioned in an oven cavity;

FIG. 30 is a section taken along the length of the bottom portion of the oven of FIG. 29 including the oven cavity and the food container in the oven cavity;

FIG. 31 is a front elevation of a bottom portion of an oven having another embodiment of a food container of the present invention in an oven cavity;

FIG. 32 is a section taken along the length of the bottom portion of the oven of FIG. 31 including the oven cavity and the food container in the oven cavity;

FIG. 33 is a front elevation of a bottom portion of an oven having another embodiment of a food container of the present invention in an oven cavity;

FIG. 34 is a section taken along the length of the bottom portion of the oven of FIG. 33 including the oven cavity and the food container in the oven cavity;

FIG. 35 is a front elevation of another embodiment of an oven of the present invention having food containers in respective upper and lower oven cavities;

FIG. 36 is a section taken along the length of a bottom portion of the oven of FIG. 35 including the lower oven cavity and the food container in the oven cavity;

FIG. 37 is a section taken along the length of a top portion of the oven of FIG. 35 including the upper oven cavity and the food container in the oven cavity;

FIG. 38 is a front elevation of a bottom portion of another embodiment of an oven of the present invention;

FIG. 39 is a front elevation of a bottom portion of another embodiment of an oven of the present invention; and

FIG. 40 is a section taken along the length of the bottom portion of the oven of FIG. 39 including an oven cavity and food container in the oven cavity.

Corresponding reference characters indicate corresponding parts throughout the drawings.

### DETAILED DESCRIPTION

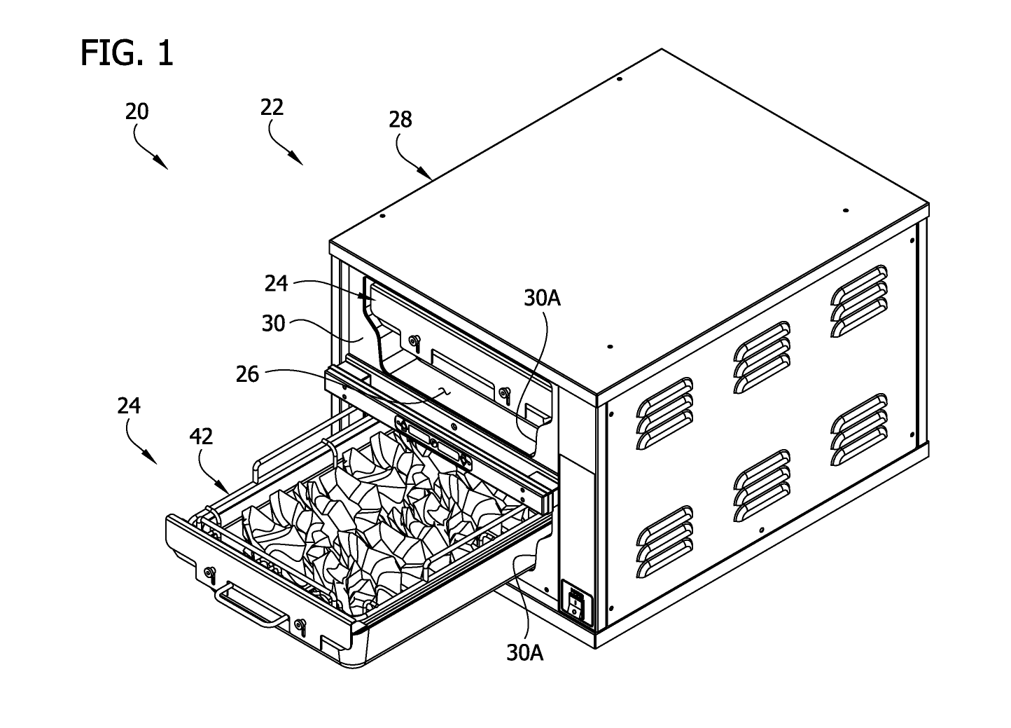

Referring to FIG. 1, one embodiment of a system of the present invention is designated generally by the reference number 20. The system includes an oven 22 and apparatus 24 for holding a plurality of food items or food products in the oven. In the illustrated embodiment, the oven has upper and lower cavities 26 sized and shaped for receiving the apparatus 24. Two apparatus 24 are shown, one fully inserted in the upper cavity 26 and the other partially inserted in the lower cavity 26. The oven 22 may be used for holding pre-cooked food items in the apparatus and/or cooking food items in the apparatus.

In one embodiment, the oven 22 is used for holding pre-cooked food items at desired temperature and humidity conditions prior to serving the food items. The apparatus 24 will accommodate a variety of food items, such as cooked hamburger patties, ham, bacon, sausage, onion rings, French toast, biscuits, fried (breaded) or grilled fish, and fried (breaded) or grilled chicken. Some cooked food items, such as hamburger patties should be held at elevated temperatures only in a moist environment because these foods, when depleted of their moisture content, have poor taste and texture. Other cooked food items, such as breaded chicken or fish, should be stored such that moisture may readily escape, so the food items remain crisp. As will become apparent, the system 20 is configured for holding a plurality of food items at temperature and humidity conditions for a holding period during which the food remains suitable for human consumption and remains appetizing to the pallet. Moreover, the system 20 may be adaptable for holding different types of food items according to temperature and humidity conditions desirable for those particular food items.

The oven 20 will now be described with reference to FIGS. 1-3. The oven 20 includes a housing or cabinet 28 having front and rear panels 30, 32. The cavities 26 in the oven 20 are accessible through respective openings 30A, 32A in the front and rear panels 30, 32. The openings 30A, 32A are sized for receiving the apparatus 24 through the openings and shaped generally corresponding to the exterior cross-sectional shape of the apparatus. Each cavity 26 is defined in part by a heat sink, generally indicated by the reference number 34, which extends along a length of the cavity 26 between the front and rear panels 30, 32. The cavities 26 have a cross-sectional shape closely conforming to the exterior cross-sectional shape of the apparatus 24, which enables the heat sinks 34 to efficiently transfer heat to the apparatus 24. Desirably, each heat sink 34 is formed from a substance that conducts heat well, such as aluminum. Heaters (not shown) are provided below the heat sinks 34 for heating the heat sinks.

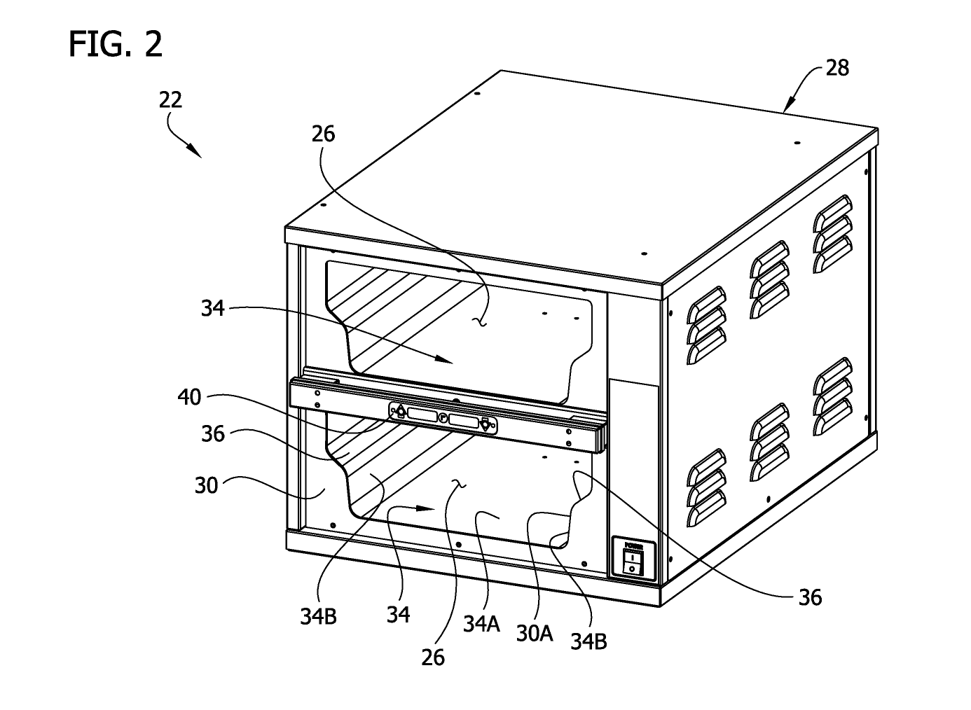

With the understanding that each cavity 26 has substantially the same construction, only the lower cavity 26 will be described in further detail. As shown in FIG. 2, the heat sink 34 has a channel shape, including a bottom wall 34A and side walls 34B extending upward from the bottom wall. The side walls have shoulders 36 which extend horizontally along the length of the cavity 26. An upper wall 38 extends between the side walls 34B and along the length of the cavity 26. The openings 30A, 32A in the front and rear panels define respective open front and open rear ends of the cavity, also indicated by 30A and 32A, respectively. In the illustrated embodiment, the openings 30A, 32A are doorless. The cavities 26, having front and rear openings 30A, 32A, may be used in a “pass-through” manner in which apparatus 24 may be inserted and/or removed from either the front or rear of the oven 20.

Ovens having other configurations such as cavities with only one open end may be used without departing from the scope of the present invention. Moreover, ovens including more or fewer columns and rows of cavities may be used without departing from the scope of the present invention.

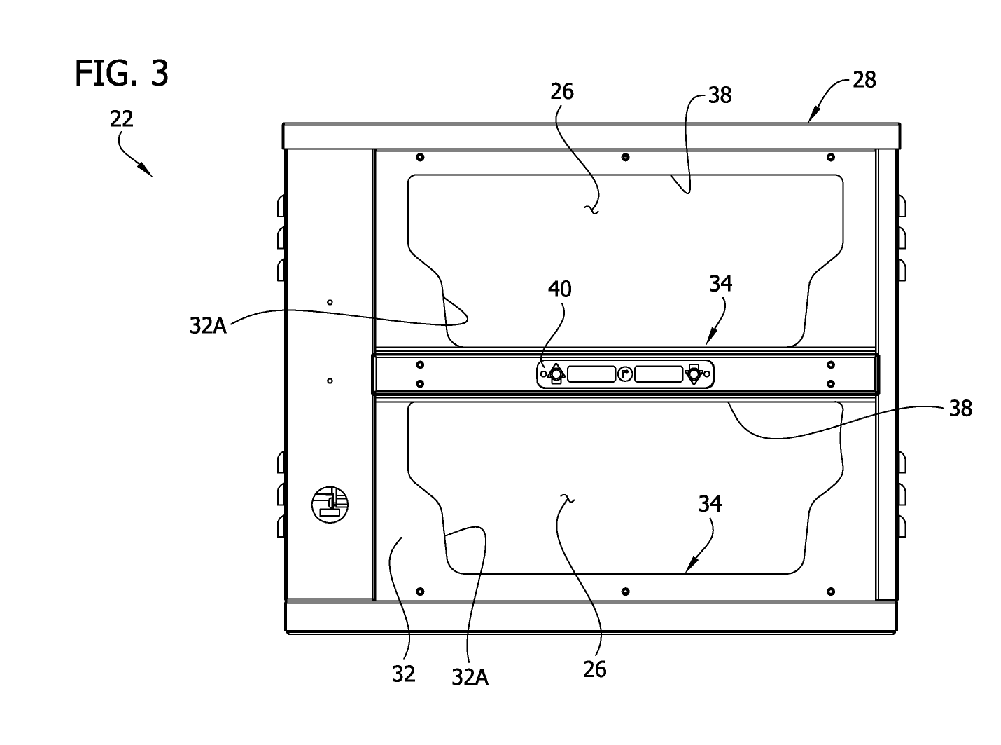

An oven similar to the illustrated heat sink oven 22 is shown and described in U.S. Pat. No. 6,175,099 (“the '099 patent”), which is hereby incorporated by reference in its entirety. As explained in the '099 patent, ovens of this type generally include electrical controls which control the temperature at which the heat sinks operate. In the illustrated embodiment, electrical controls are provided on the front and rear of the oven 20 and are indicated generally by the reference number 40 in FIGS. 2 and 3. The apparatus 24 in the upper and lower cavities 26 may contain different food items, and the heat sinks 34 in the upper and lower cavities may be operated differently according to the desired conditions for the different food items, as is know by persons having ordinary skill in the art.

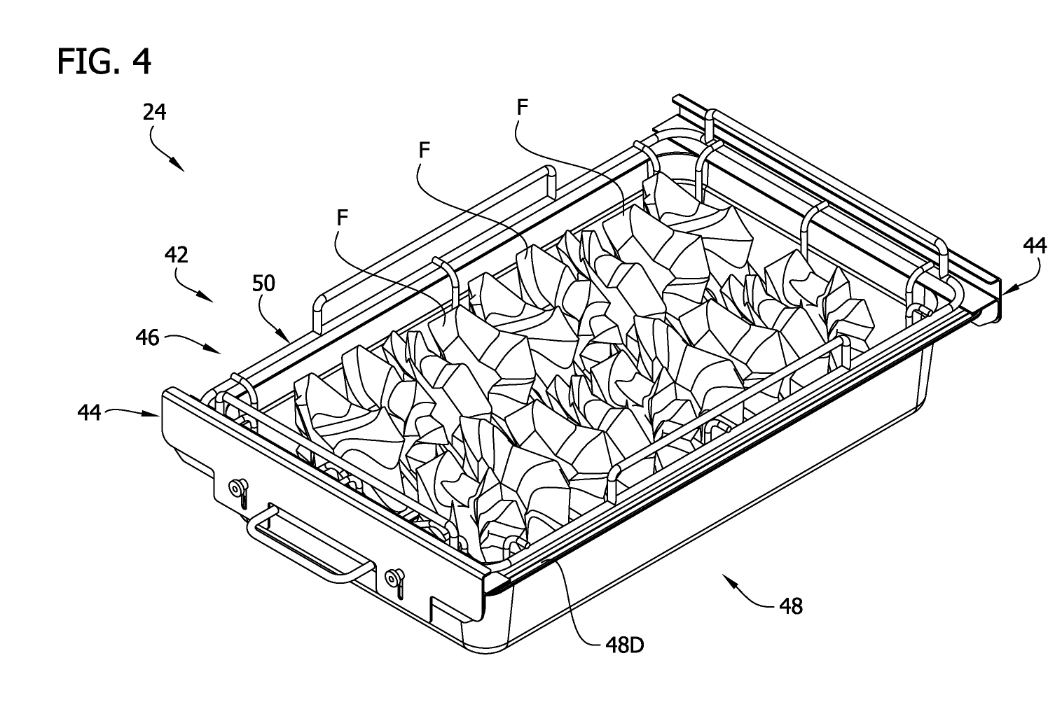

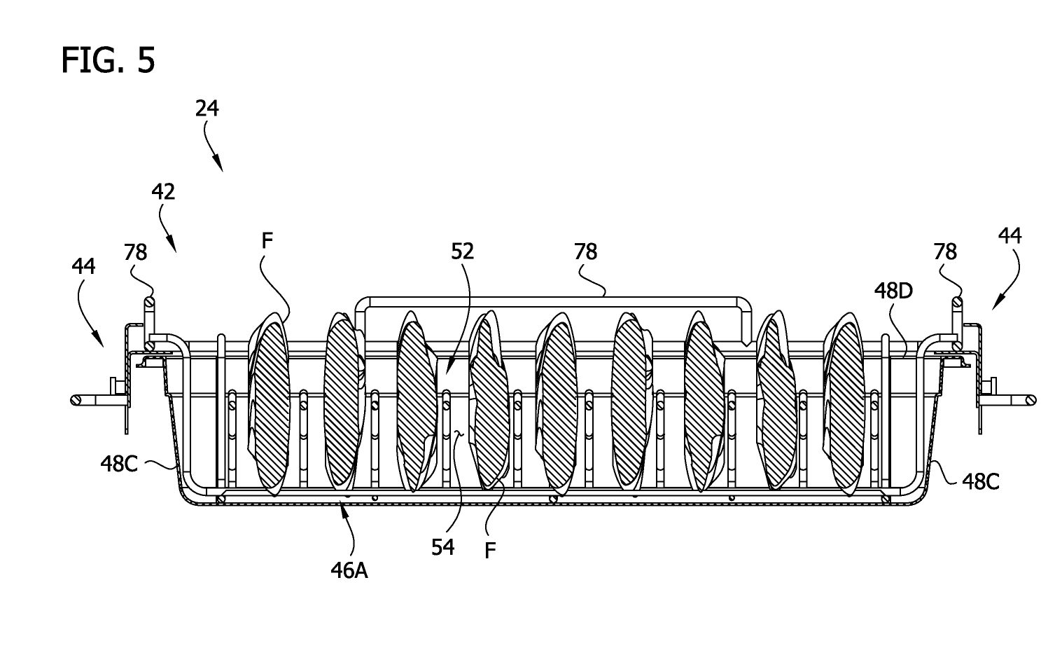

Referring now to FIG. 4, the apparatus 24 is shown in perspective and having a plurality of food items F received therein. FIG. 5 illustrates a cross section taken lengthwise along the apparatus 24. The illustrated food items F represent fried chicken items or fried chicken products having a generally flat shape. The apparatus 24 includes a food container, generally indicated by the reference number 42, and baffles, generally indicated by the reference numbers 44, attached to opposite ends of the food container. As described in further detail below, the baffles 44 restrict gas flow out of the food container 42 through the front and rear open ends 30A, 32A of the cavity 26.

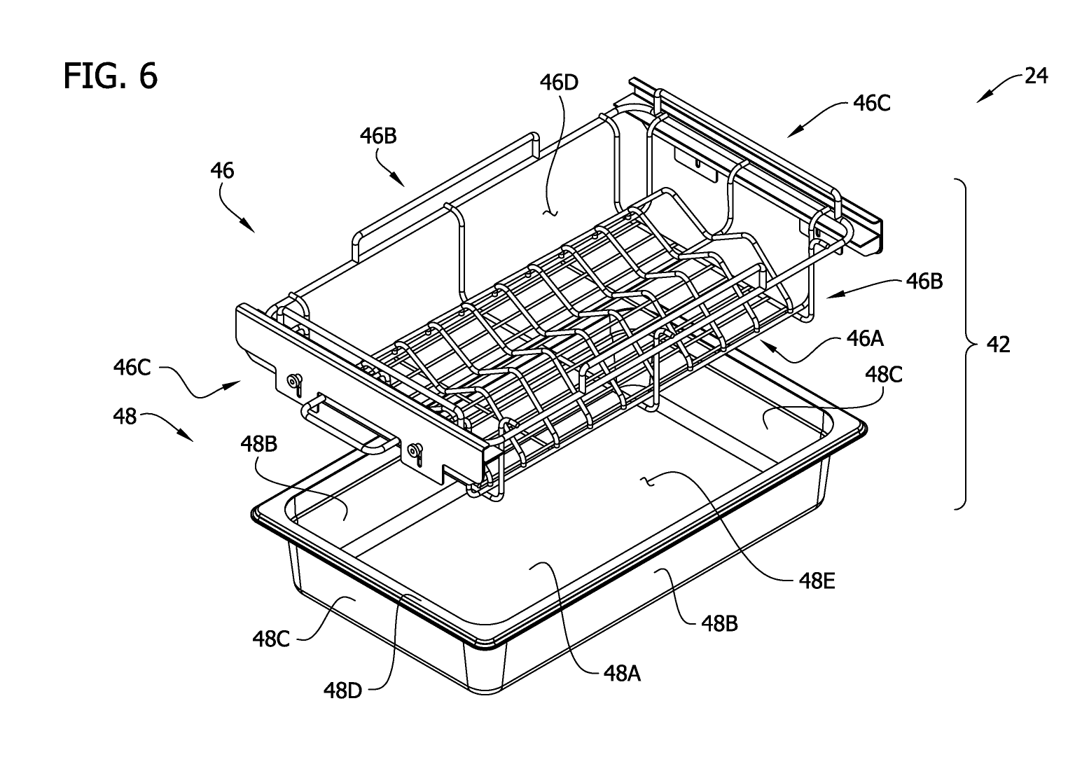

Referring to FIG. 6, the food container 42 includes a rack, generally designated by the reference number 46, and a tray, generally designated by the reference number 48. The rack 46 is shown separated from the tray 48 in FIG. 6. The tray 48 has a bottom wall 48A, opposite side walls 48B extending upward from the bottom wall, and opposite end walls 48C extending upward from the bottom wall and connecting the respective side walls. The tray 48 includes a compartment above the bottom wall 48A and between the side walls 48B and end walls 48C. The tray 48 also has a peripheral rim 48D and an open top 48E. The tray 48 is sized and shaped for receiving the rack 46. In the assembled form of the food container 42, the rack 46 is received in the open top 48E and compartment of the tray 48 and is supported on an upper surface of the bottom wall 48A of the tray. The tray 48 may be formed of a molded polymer or other suitable material (e.g., stamped metal).

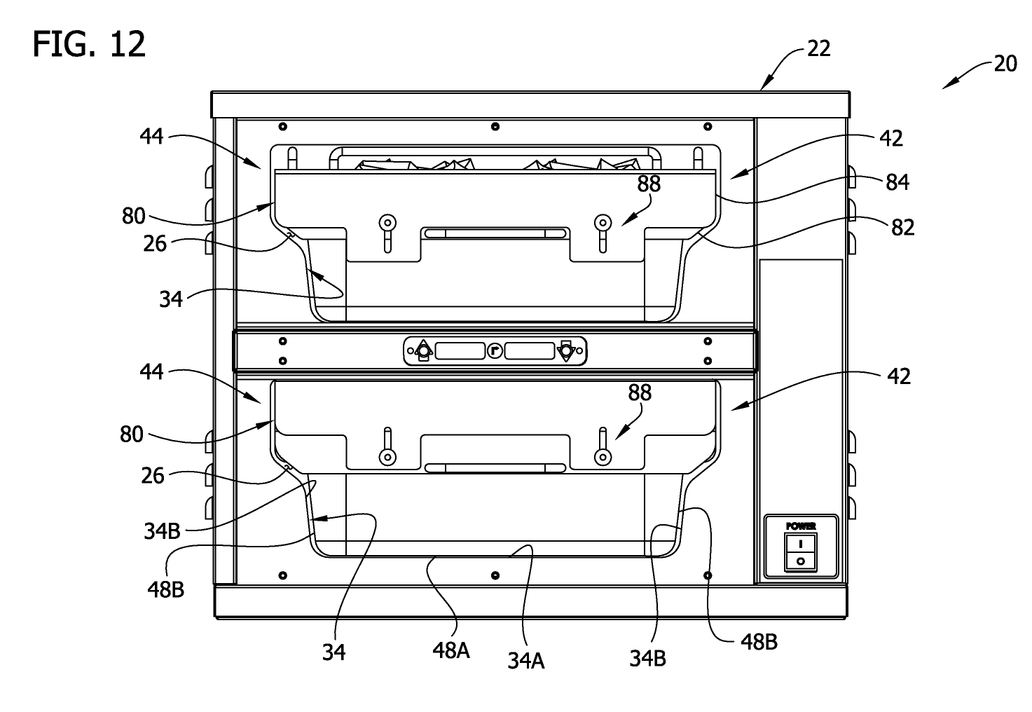

As shown in FIG. 12, the food container 42 has an exterior cross-sectional shape closely conforming to the shape of the heat sink 34. In particular, the bottom wall 48A and side walls 48B of the tray 48 are sized and shaped for closely conforming to the bottom wall 34A and side walls 34B of the heat sink 34. As explained above, this close conformance in shape enhances the efficiency of heat transfer from the heat sink 34 to the food container 42.

In the illustrated embodiment, the food container 42 is lidless. More specifically, when the container 42 is placed in the oven cavity 26, a lid is not used which covers or extends horizontally across a substantial portion of the open top 48E of the tray 48. Because the food container 42 is lidless, gas is permitted to flow vertically in the cavity 26 in the space between the tray 48 and the upper wall 38 of the cavity 26. The baffles 44 may be used instead of a lid. All of the food containers disclosed herein are lidless. However, a lid may be used without departing from the scope of the present invention.

Referring again to FIG. 6, the rack 46 of the illustrated embodiment is formed of wire segments or bars made of, for example, stainless steel. In general, the rack 46 has a bottom 46A, opposite sides 46B, opposite ends 46C, and an open top 46D. The rack 46 has a width extending between the sides 46B and a length extending between the ends 46C. The length of the rack 46 may be greater than, about the same as, or less than its width.

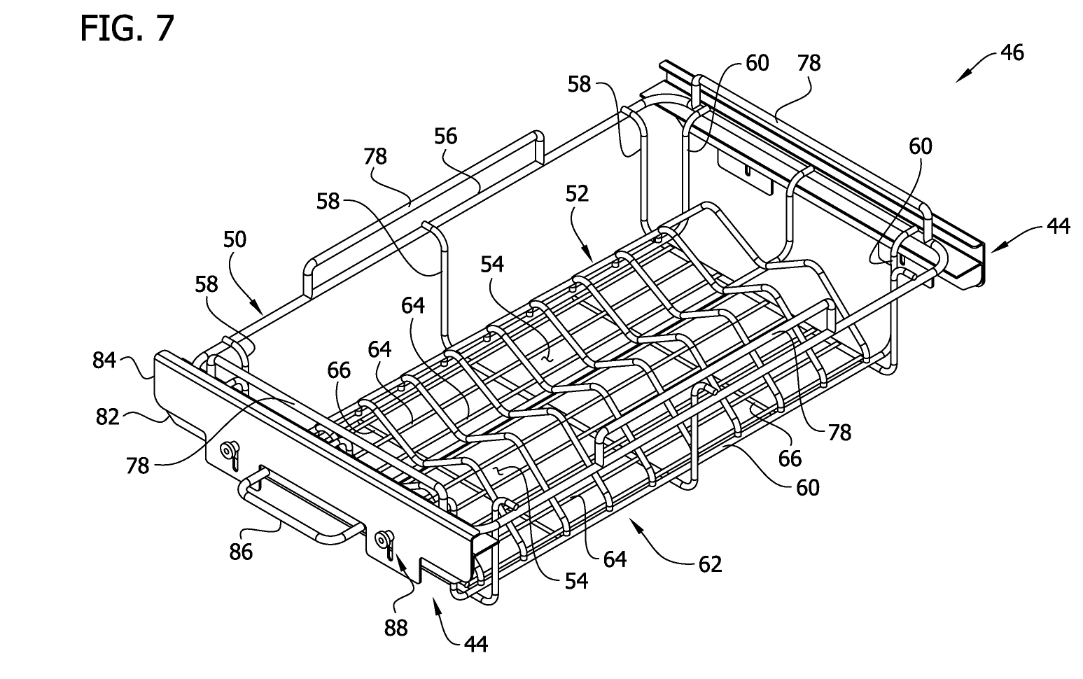

Referring to FIG. 7, the rack 46 includes a frame, generally indicated by the reference number 50, and a holding device, generally designated by the reference number 52. The frame 50 is sized and shaped for being received on the tray 48. The holding device 52 is supported by the frame 50 and is configured for holding food items F in an orientation in which the food items are spaced from one another. More specifically, the holding device 52 defines a plurality of slots 54 for receiving the food items. Holding devices having other configurations may be used without departing from the scope of the present invention. For example, the holding device may not include slots, and the holding device may not maintain food items spaced from one another.

As shown in FIG. 7, the frame includes a rectangular member 56, width-wise U-shaped braces 58 spanning a width of the rectangular member, and length-wise U-shaped braces 60 spanning a length of the rectangular member. Base portions of the U-shaped braces 58, 60 support a bed, generally indicated by the reference number 62. The bed is formed by a plurality of generally parallel length-wise bars 64 extending along the length of the rack 46 and spaced from each other at intervals along the width of the rack. The bed 62 also includes width-wise bars 66 extending along the width of the rack 46 and spaced from each other at intervals along the length of the rack. When the rack 46 is received on the tray 48, the rectangular member 56 is positioned generally above and in register with the peripheral rim 48D of the tray, and the holding device 52 is positioned in the tray compartment between the side walls 48B and between the end walls 48C of the tray.

In the illustrated embodiment, the bottom 46A of the rack 46 is a grid having openings for permitting liquid to drain from the food items downward through the openings and collect on the upper surface of the bottom wall 48A of the tray 48. For example, breaded chicken, after being fried, includes liquid grease and water in the skin, breading, and meat. Some of the grease and water drains from the food items downward through the openings in the bottom 46A and collects on the bottom wall 48A of the tray 48. The rack 46 maintains the food items spaced above the bottom wall 48A to prevent the food items F from contacting pooled grease or water.

Referring still to FIG. 7, the rack 46 also includes bumpers 78 at an upper end of the frame 50 adjacent the open top 46D of the rack 46. In the illustrated embodiment, four bumpers 78 are provided, one along each side 46B and end 46C of the rack 46. The bumpers 78 are upside-down U-shaped bars having ends connected to the rectangular member 56 and bases or upper portions which are spaced above the frame 50. The bumpers 78 are configured for contacting the upper wall 38 of the oven cavity 26 if the rack 46 is moved toward the upper wall to prevent the food items from contacting the upper wall. For example, when inserting or removing the rack 46 from the cavity 26, an end 46C or side 46B of the rack may be inadvertently moved toward the upper wall 38 of the cavity 26. As shown in FIG. 5, the upper portions of the bumpers 78 are spaced above the bottom 46A of the rack 46 a distance more than the height of the food item F as it is positioned on the rack such that the upper portions of the bumpers 78 are higher than the highest portion of the food item F in the slot 54. In other words, as evident in FIG. 5, the upper portions of the bumpers 78 would contact the upper wall 38 of the oven cavity 26 before the food items F would contact the upper wall. Moreover, the bumpers 78 are configured to require the apparatus 24 to be maintained in a generally horizontal orientation while being inserted in and removed from the cavity 26. In other words, minimal rotation of the apparatus 26 about a width-wise axis or about a length-wise axis would cause one or more of the bumpers 78 to contact the upper wall 38 of the cavity 26, preventing further or significant rotation.

Racks having other configurations may be used without departing from the scope of the present invention. For example, a rack not having slots 52 for holding food items (e.g., having a flat bed) may be used. In addition, other numbers of bumpers 78 or bumpers having other configurations may be used without departing from the scope of the present invention. For example, the bumpers 78 on the ends of the rack may be omitted, or the bumpers 78 on the sides of the rack may be omitted. Moreover, all bumpers 78 may be omitted from the rack without departing from the scope of the present invention. In addition, in some embodiments, the rack 46 may be omitted without departing from the scope of the present invention.

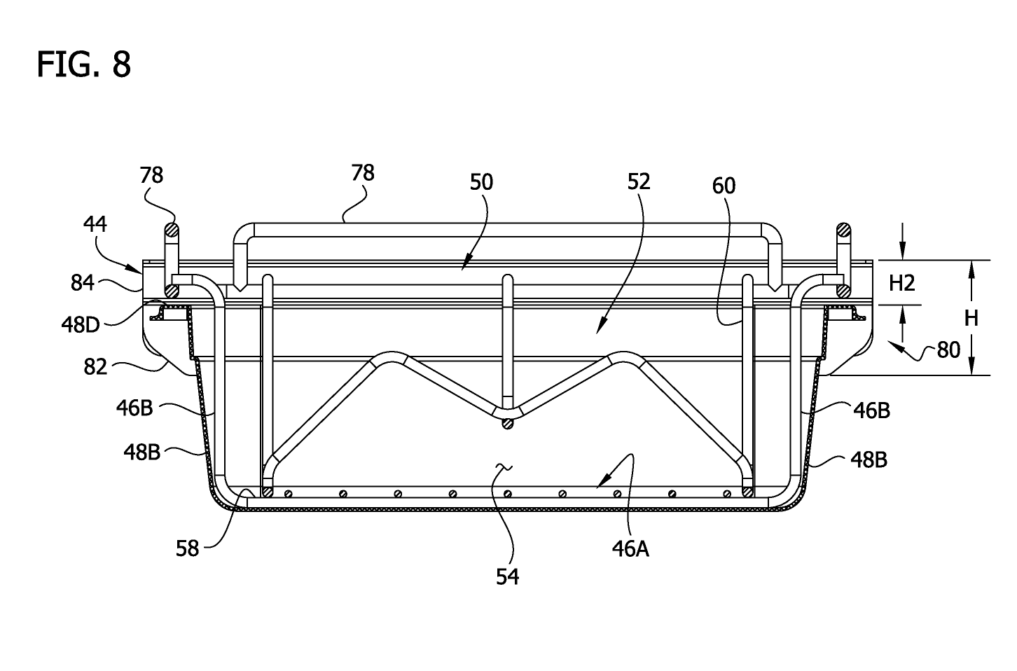

Referring again to FIG. 4, the baffles 44 are attached to the food container 42 at opposite ends of the food container. More specifically, the baffles 44 are attached to opposite ends of the frame 50 of the rack 46. Alternatively, as described in further detail below, the baffles 44 may be attached to opposite ends of the tray 48. The baffles 44 are provided for restricting gas flow from the food container 42 out of the open ends 30A, 32A of the cavity 26, i.e., regulating passive venting of the food container. The baffles 44 are positioned on the container 42 to extend above the peripheral rim 48D of the tray 48 for obstructing a flow path between the peripheral rim and the upper wall 38 of the oven cavity 26. As shown in FIG. 5, in the illustrated embodiment, the baffles 44 are positioned adjacent to the end walls 48C of the tray 48. As shown in FIG. 8, the baffles 44 extend width-wise beyond the sides 46B of the rack 46 and also beyond the side walls 48B of the tray 48. Desirably, the baffles 44 have a width which extends across substantially all of or is not substantially less than the width of the open ends of the oven cavities 26. However, baffles having other widths may be used without departing from the scope of the present invention.

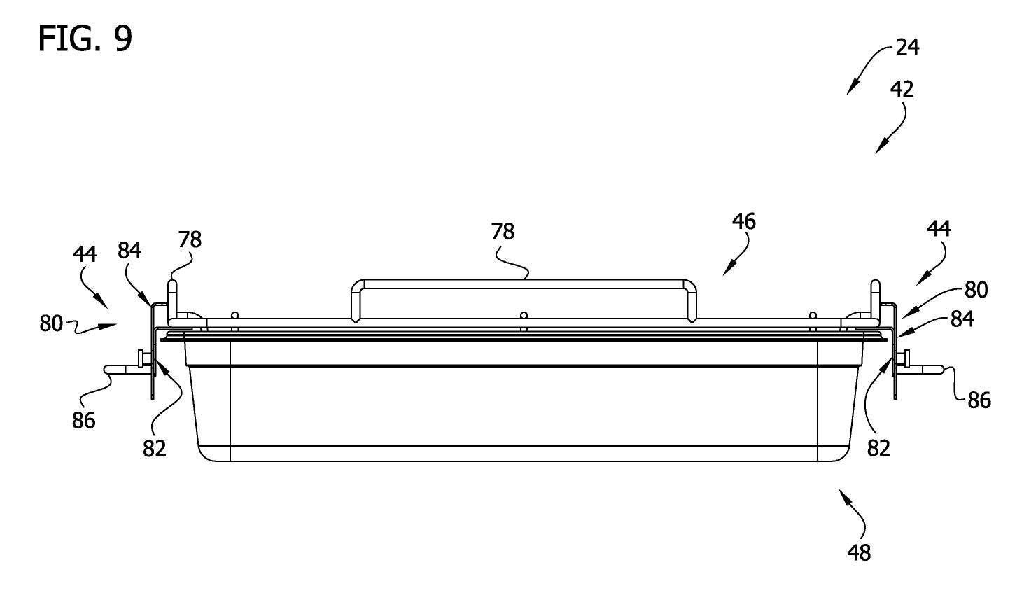

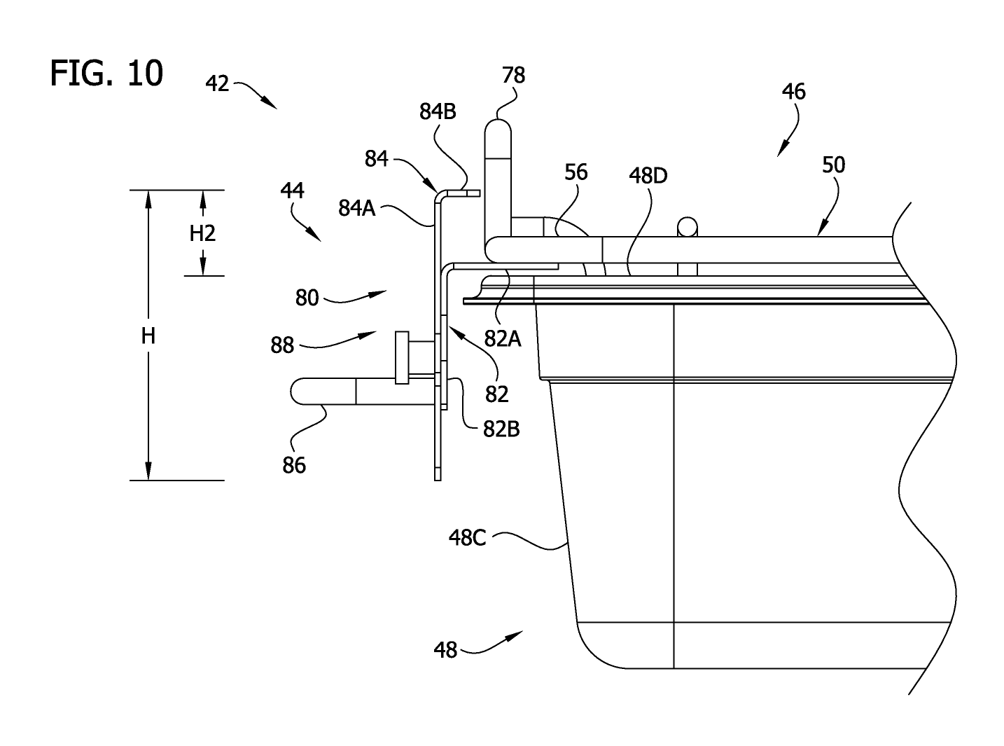

Referring to FIGS. 9-11, each baffle 44 forms a generally upright or upstanding wall 80 for restricting gas in the cavity 26 from flowing out of the open ends 30A, 32A of the cavity. In the illustrated embodiment, each baffle 44 includes a base, generally indicated by the reference number 82, and an upper or movable member, generally indicated by the reference number 84. The base 82 comprises an angled plate having a generally horizontal portion 82A extending along the width of the food container 42 and a generally upright portion 82B also extending along the width of the food container. The base 82 is fixed (e.g., attached via spot welds) to a lower side of the rectangular member 56 of the rack 46. Handles 86 are provided on the bases 82 of the baffles 44 for use in carrying the rack 46. The movable member 84 comprises an angled plate having a generally upright or upstanding wall portion 84A extending along the width of the food container 42 and a generally horizontal flange or lip 84B extending along the width of the food container and projecting inboard from an upper end of the generally upright wall portion for potentially engaging the upper wall 38 of the cavity 26. The generally upright portion 82B of the base 82 and the generally upright or upstanding wall portion 84A of the movable member form the generally upright or upstanding wall 80.

In the illustrated embodiment, the wall 80 is generally continuous or non-perforated along its height and width. In other embodiments, vents or openings may be provided in the wall for permitting flow of gas through the wall. Moreover, a damper (e.g., a sliding damper) may be provided for adjusting the flow area of openings through the wall.

As shown in FIGS. 8, 10, and 12, the wall 80 has a height H extending from at least the peripheral rim 48D to a position above the peripheral rim for restricting gas flow out of the container 42 through a gap between the peripheral rim and the upper wall 38 of the cavity 26. In the illustrated embodiment, the upright wall portion 84A of the movable member 84 forms substantially all of the height H2 of the wall 80 above the peripheral rim 48D. The upright portion 82B of the base 82 extends below the peripheral rim 48D of the tray 48 for restricting gas flow out of the cavity 26 through the areas between the side walls 48B of the tray 48 and respective side walls 34B of the heat sink 34 (e.g., above the shoulders 36). This enhances the efficiency of heat transfer from the heat sink 34 to the food container 42.

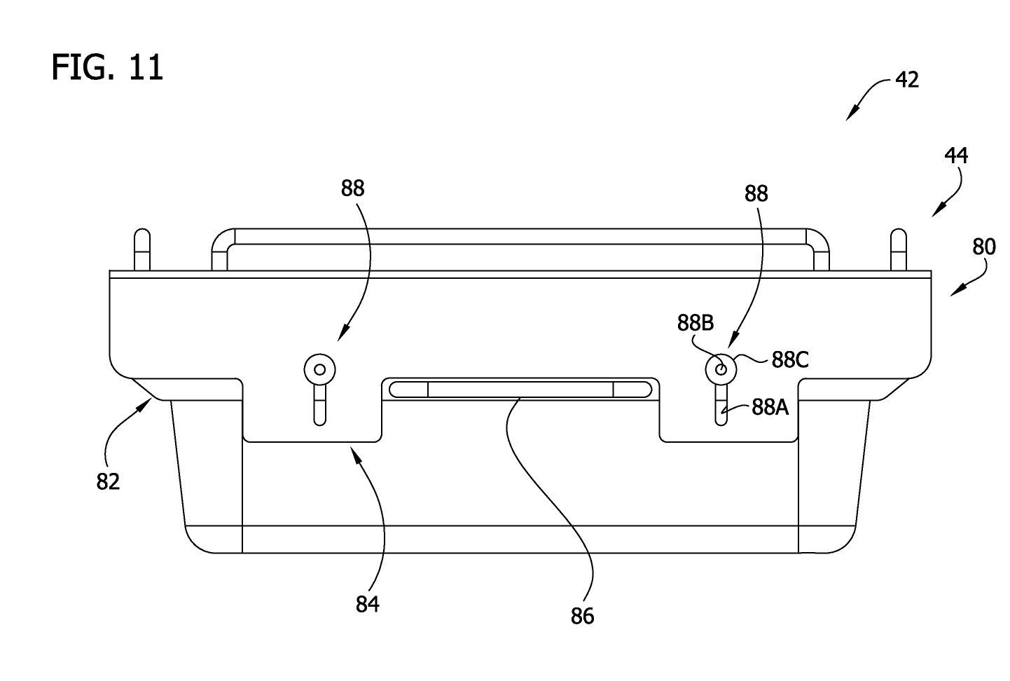

In the illustrated embodiment, each baffle 44 is adjustable for adjusting a height of the wall 80. As shown in FIG. 11, the movable member 84 is connected to the base 82 by releasable slot connections, generally indicated by the reference number 88. Each slot connection 88 includes a generally vertical slot 88A in the movable member 84, a threaded bolt 88B mounted on the base 82 which extends through the slot, and a nut 88C (broadly “securing member”) which, when tightened on the bolt, holds the movable member 84 in adjusted position with respect to the base. The tightened position of the nut 88C on the bolt 88B may be referred to as a securing position. When the nut 88C is moved from the tightened position to a loosened position, the movable member 84 is permitted to slide upward or downward. The slots 88A are provided on extensions extending down from a lower end of the movable member 84. Alternatively, each slot 88A may be replaced by a plurality of openings (e.g., circular openings) aligned vertically and spaced from each other permitting the movable member 84 to be moved incrementally by raising or lowering the movable member to a position corresponding to a set of the plurality of openings. Other adjustment mechanisms may be used without departing from the scope of the present invention.

As is now apparent, the baffles 44 are adjustable for permitting adjustable restriction of the gas flow from the container 42 out of the open ends 30A, 32A of the cavity 26. More specifically, in the illustrated embodiment, the movable member 84 is movable vertically with respect to the base 82 by loosening the nuts 88C, moving the movable member to a desired position with respect to the base, and then tightening the nuts to secure the movable member in the desired position. This vertical movement adjusts the height H2 of the top of the wall 80 with respect to the peripheral rim 48D. As shown in FIG. 12, referring to the apparatus 24 in the lower cavity 26, the movable member 84 has an upper position in which substantially all gas flow from inside the food container 42 is blocked from exiting the open ends 30A, 32A of the cavity 26 along the flow path between the peripheral rim 48D and the upper wall 38 of the cavity 26. Moreover, referring to the apparatus 24 in the upper cavity 26 in FIG. 12, the movable member 84 has a lower position in which at least some but not all of the gas flow is blocked from exiting the open ends 30A, 32A of the cavity along the flow path. As described in further detail below, in other embodiments, the connections of the base 82 and movable member 84 may be configured so the upper end of the movable member is lower when the movable member is in its lower position, such that substantially none of the gas flow from inside the container 42 is blocked from exiting the open ends 30A, 32A of the cavity 26 along the flow path.

As mentioned above, the necessity to vent moisture from the apparatus 24 depends on the particular type of food item F in the apparatus. Certain food items, such as roasted, steamed, or grilled food items (e.g., hamburger patties, chicken, and fish), need to be held in a relatively moist environment to prevent them from drying out and becoming undesirable to the pallet. To maintain suitable moisture in these types of food items, it may be necessary to block at least some, most, or even substantially all of the gas flow from exiting the food container 42 out of the open ends 30A, 32A of the cavity 26. Other food items may require moisture to be more rapidly evacuated (e.g., passively vented) from the food container 42. For example, breaded chicken requires a substantial amount of gas venting for the meat to remain tender and moist, and the breading to remain dry, crispy, and intact with the meat. Suitable levels of venting or blocking of gas flow from the food container 42 may be determined for any particular food item F by testing. The baffles 44 may be adjusted accordingly to hold the food items F in the cavity 26 at temperature and humidity conditions for a holding period (e.g., at least 90 minutes for breaded chicken) during which the food items remain suitable for human consumption and remain appetizing to the pallet.

In use, a type of food item F is selected, and a plurality of the food items is received in the slots 54 of the apparatus 24 in the spaced and upright orientation. The baffles 44 may be adjusted to permit a desired amount of gas flow to exit the apparatus 24 through the front and rear openings 30A, 32A of the cavity 26. The apparatus 24 is inserted in an oven cavity 26, and the oven 22 is operated to hold the food items F at desired temperature and humidity conditions for a holding period during which the food remains suitable for human consumption and remains appetizing to the pallet.

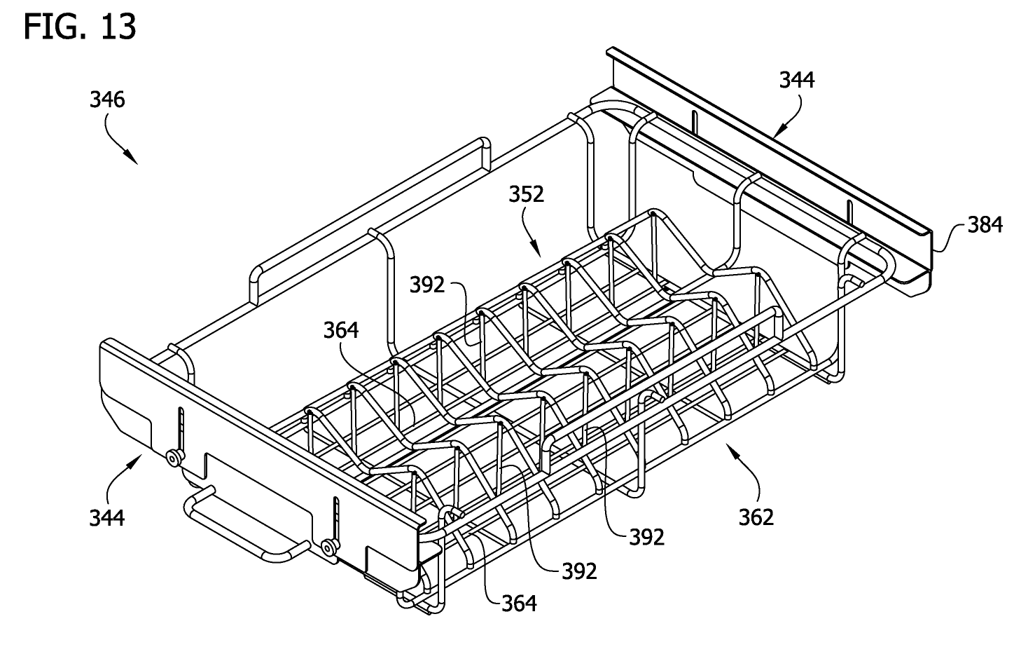

Referring to FIGS. 13-16, another embodiment of an apparatus of the present invention is generally indicated by the reference number 324. The apparatus 324 of this embodiment is similar to the apparatus 24 described above, and similar parts are indicated by corresponding reference numbers, plus 300. For example, the apparatus 324 includes a food container 342 having a rack 346 and a tray 348. The apparatus 324 also includes baffles 344 attached to the food container 342. The apparatus 324 are illustrated in the same oven 22 as the previous embodiment.

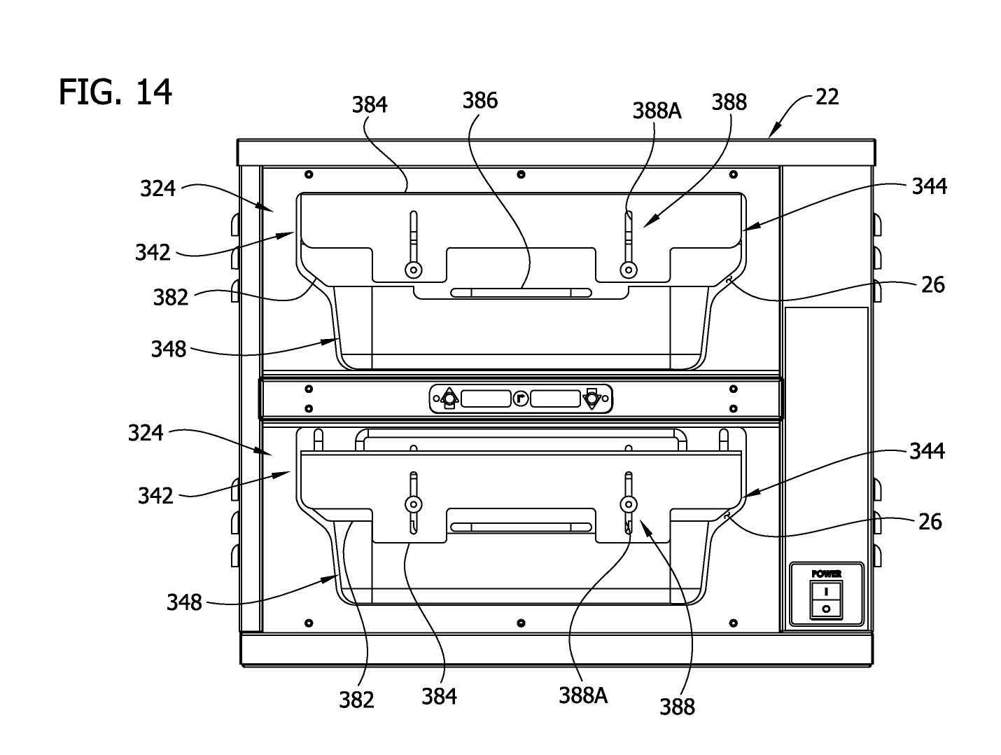

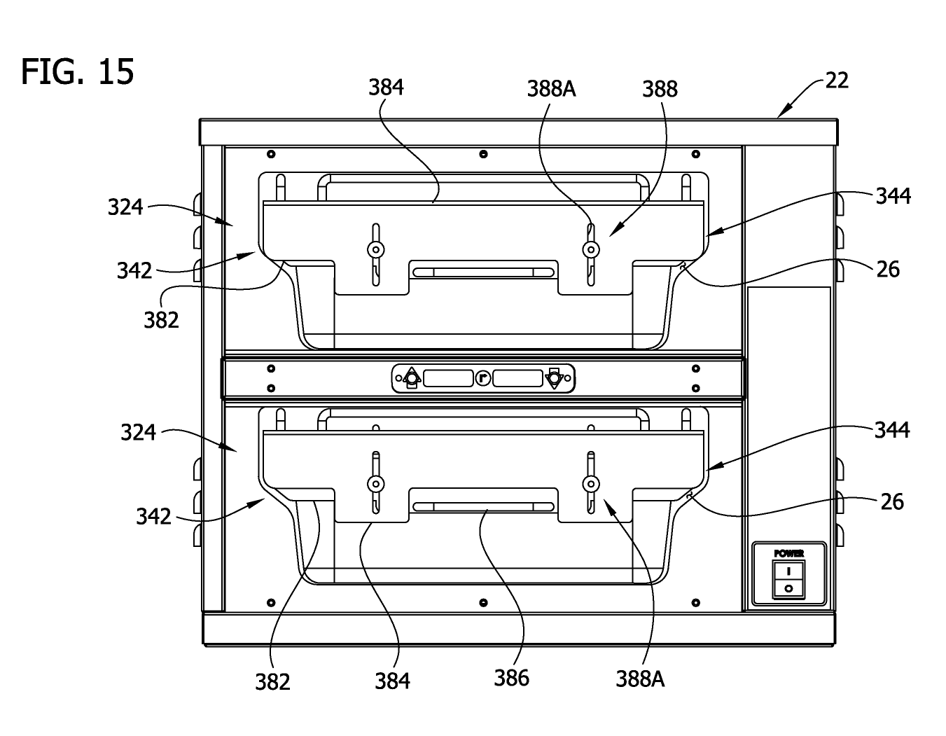

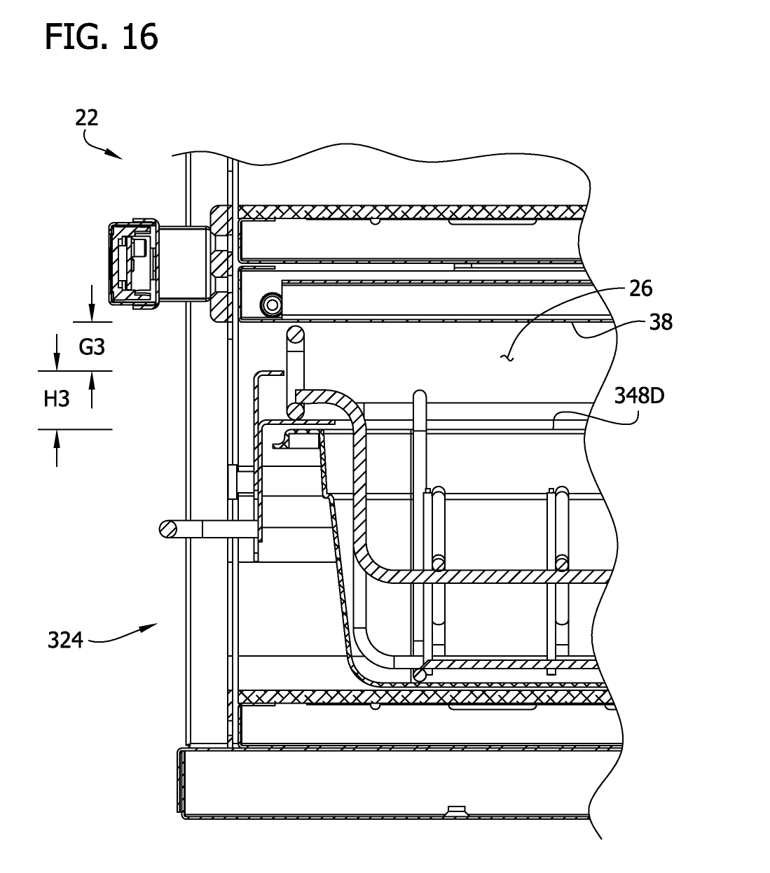

In this embodiment, the baffles 344 are modified. The baffles 344 are different in that the upper or movable member 384 may be moved lower with respect to the base 382 than the movable member 84 of the apparatus 24 described above. More specifically, the releasable slot connections 388 include slots 388A which are longer to provide an increased vertical range of movement of the movable member 384 relative to the base 382. The base 382 includes a downward projecting extension on which the handle 386 is located for accommodating the increased downward movement of the movable member 384. The baffle 344 is adjustable as explained with respect to the baffle 44 above. For example, as shown in FIG. 14, referring to the apparatus 324 in the upper cavity 26, the movable member 384 has an upper position in which the baffle has a height above the peripheral rim such that substantially all gas flow from inside the food container 342 is blocked from exiting the open ends 30A, 32A of the cavity 26 along the flow path between the peripheral rim 348D and the upper wall 38 of the cavity 26. As also shown in FIG. 14, referring to the apparatus 324 in the lower cavity 26, the movable member 384 has an intermediate position in which the baffle has a height H3 above the peripheral rim such that at least some but not all of the gas flow is blocked from exiting the open ends 30A, 32A of the cavity 26 along the flow path. FIG. 16 illustrates a section of this apparatus 324 showing in closer detail the height H3 that the baffle 344 extends above the peripheral rim 348D and the gap G3 between the upper end of the movable member 384 and the upper wall 38 of the oven cavity 26 through which gas is permitted to flow out of the food container 342. Moreover, as shown in FIG. 15, referring to the apparatus 324 in the upper cavity 26, the movable member 384 has a lower position in which the movable member has a insubstantial or no height above the peripheral rim 348D such that substantially none of the gas flow from inside the container 342 is blocked from exiting the open ends 30A, 32A of the cavity 26 along the flow path. Moreover, the movable member 384 may be positioned in other locations between the upper and lower positions.

As described above, a desired position for the movable member 384 (i.e., height above the peripheral rim) may be selected based on the determined venting requirements for a particular food item F to be held in the apparatus 324. For example, for food items such as breaded (fried) chicken fillets, the movable member 384 may be positioned to provide the gap G3 measured vertically between the upper end of the movable member (upper lip or flange of the movable member) and the upper wall 38 of the cavity 26 of less than about 0.25, 0.5, 0.75, 1, 1.25, 1.5, 1.75, or more inches. In one embodiment, the gap G3 may be about 0.5 inches, and in another embodiment the gap may be about 0.75 inches.

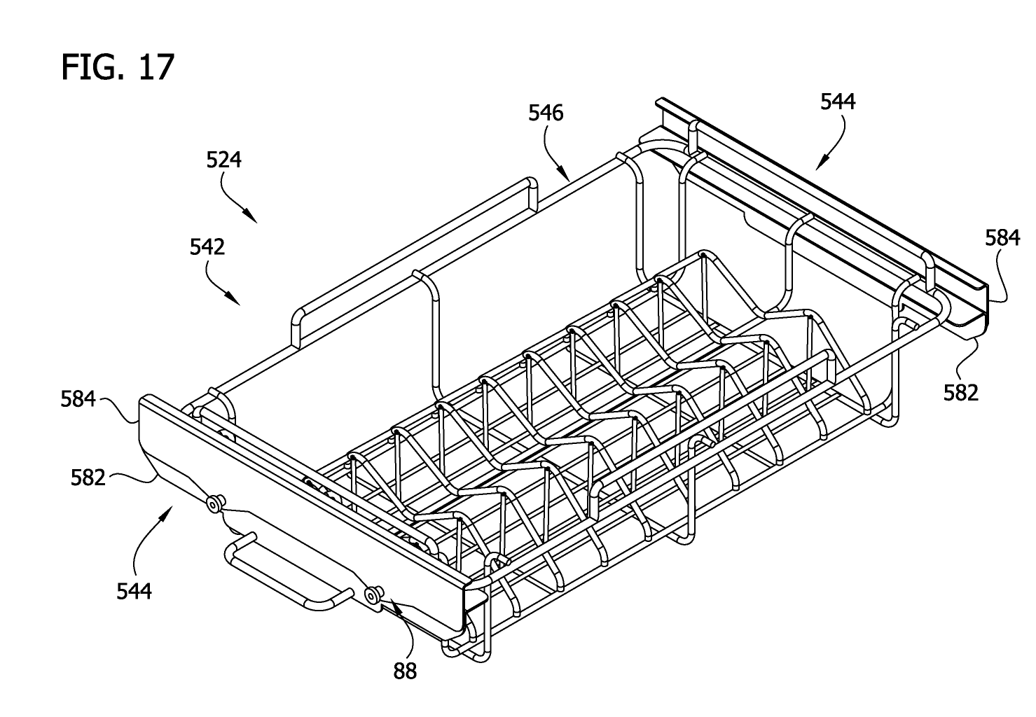

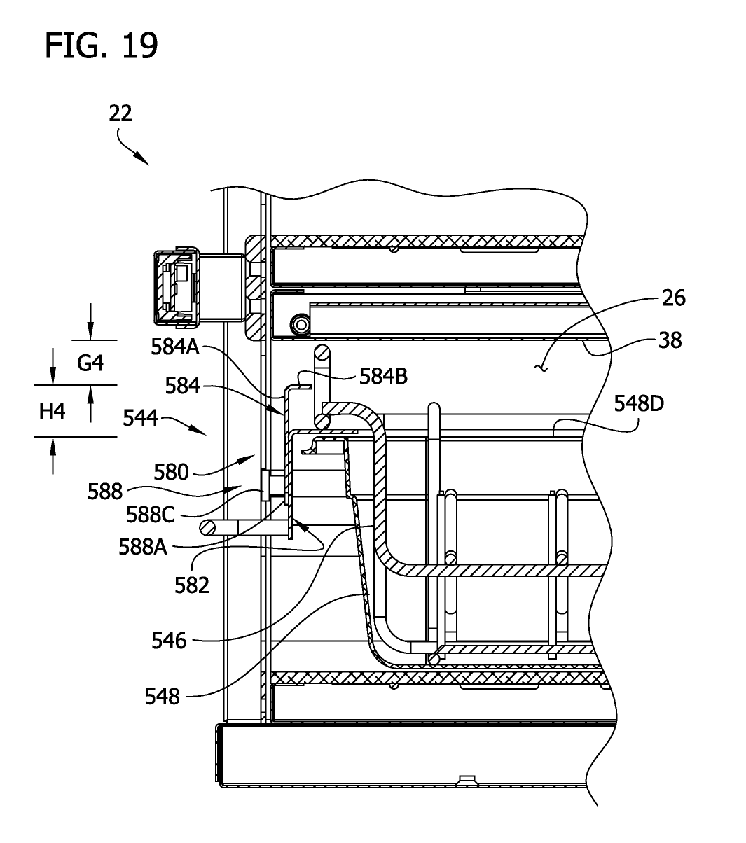

Referring to FIGS. 17-19, another embodiment of an apparatus of the present invention is generally indicated by the reference number 524. The apparatus 324 is shown in the oven 22. The apparatus of this embodiment is similar to the apparatus 324 described above, and similar parts are indicated by corresponding reference numbers, plus 200. For example, the apparatus 524 includes a food container 542 having a rack 546 and a tray 548. The apparatus 524 also includes baffles 544 attached to opposite ends of the food container 542. As with the baffles described above, each of the baffles 544 form a generally upright or upstanding wall 580 for restricting gas from flowing from the cavity 26 out of the open ends 30A, 32A of the cavity 26. As shown in FIGS. 17 and 19, the baffles 544 each include a base 582, which is substantially similar to the base 382 described above, and an upper member 584. In this embodiment, the baffles 544 are not adjustable by moving the upper members 584 vertically. The upper members 584 each comprise an angled plate having a generally upright portion 584A extending along the width of the food container and a generally horizontal flange or lip 584B extending along the width of the food container and projecting inboard from an upper end of the generally upright portion for potentially engaging the upper wall 38 of the cavity 26. The upright portion 584A of the upper member 584 extends at least from the peripheral rim 548D of the tray 548 to a position above the peripheral rim for restricting gas flow out of the container 542 along a flow path between the peripheral rim and the upper wall 38 of the cavity 26.

As shown in FIG. 19, the upper member 584 is connected to the base 582 by releasable connections, generally indicated by the reference number 588. The connections 588 each include a generally circular opening 588A in the upper member 584, a threaded bolt 588B mounted on the base 582 which extends through the opening, and a nut 588C, which when tightened on the bolt, holds the upper member in position with respect to the base. The connections 588 are different from the connections 88 essentially in that the slots 88A are replaced with circular openings 588A, which do not permit vertical movement of the upper member 584 with respect to the base 582. Accordingly, the height of the baffle 544 above the peripheral rim 548D is fixed.

Referring still to FIG. 19, the illustrated upper member 584 has a fixed height H4 for blocking about half of the distance between the peripheral rim 548D and the upper wall 38 of the cavity 26. The illustrated upper member 584 has a size which corresponds generally to the position of the movable member 384 when in its intermediate position, as shown in the lower cavity 26 in FIG. 14. A gap G4 is provided between the top of the baffle 544 and the upper wall 38 of the oven cavity 26.

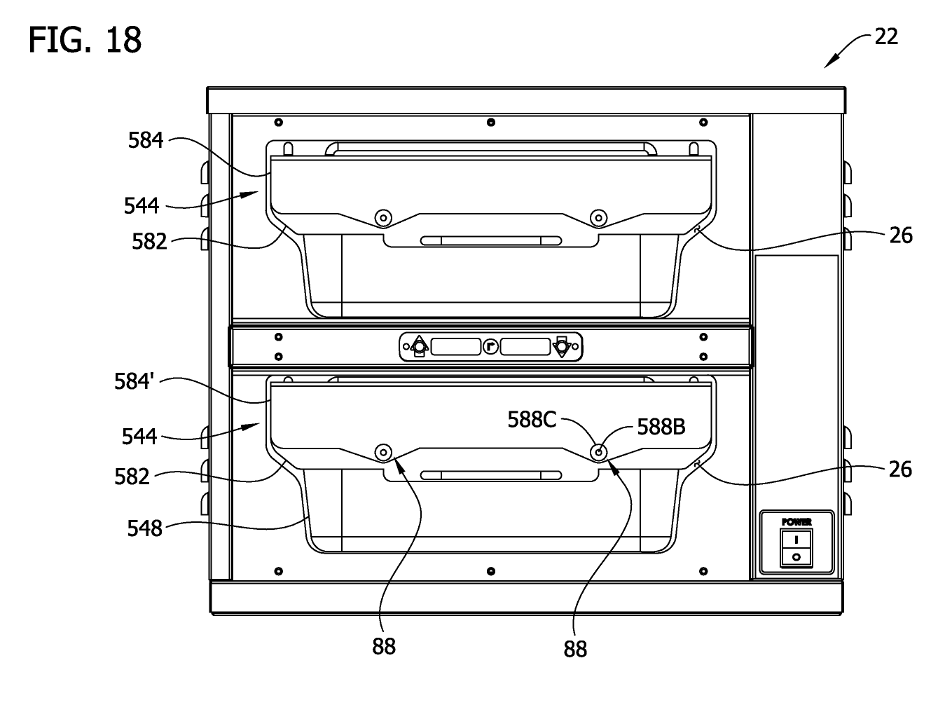

FIG. 18 illustrates the apparatus 524 including the upper baffle member 584 in the upper oven cavity 26. In addition, the apparatus 524 including a similar but taller upper baffle member 584’ is shown in the lower oven cavity 26. Upper baffle members having different configurations (e.g., extending to different heights above the peripheral rim 548D) such as upper members 584 and 584′ may be provided as a kit such that the user can select which upper members to install to achieve or restrict desired gas flow. The upper members 584, 584′ have releasable connections 588 with the rack for permitting the upper members to be interchanged. The apparatus 524 may be adjusted for a particular food product by changing the upper members 584, 584′, i.e., removing one upper member from the rack 546 and installing a differently sized upper member (e.g., having a different height) in its place. In other words, the baffle 544 is adjusted by exchanging upper members, not by moving an upper member, like in embodiments described above.

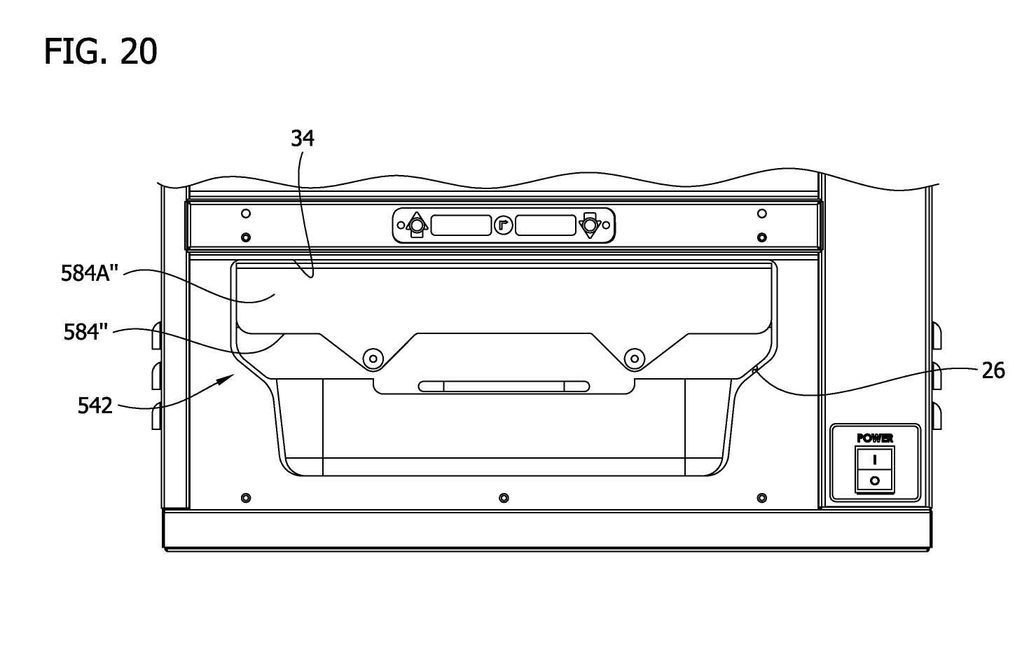

Upper members having other sizes or shapes may be used (or provided as part of the kit) without departing from the scope of the present invention. For example, as shown in FIG. 20, an upper member 584″ may be used which has an upright portion 584″ having a height extending at least from the peripheral rim of the tray to a position above the peripheral rim immediately below or in contact with the upper wall 38 of the oven cavity 26 for blocking substantially all gas flow out of the food container 542 along the flow path between the peripheral rim and the upper wall 38 of the cavity 26. The upper member 584″ has a height less than H4 of the upper member 584 and which corresponds to the position of the movable member 384 when in its upper position, as shown in the upper cavity 26 in FIG. 14.

Moreover, the baffles 544 may be connected to the food container 542 in other ways than shown. For example, the upper members 584, 584′, 584″ may be fixed (e.g., welded) to the bases. In addition, the bases 542 may be omitted, and the upper members 584, 584′, 584″ be attached to the food container without using the bases 582, such as by welding the upper members directly to the rack. Alternatively, the upper members 584, 584′, 584″ may be attached to the tray 548 (e.g., adjacent the peripheral rim 548D), as described in further detail below. Baffles having other configurations may be used without departing from the scope of the present invention.

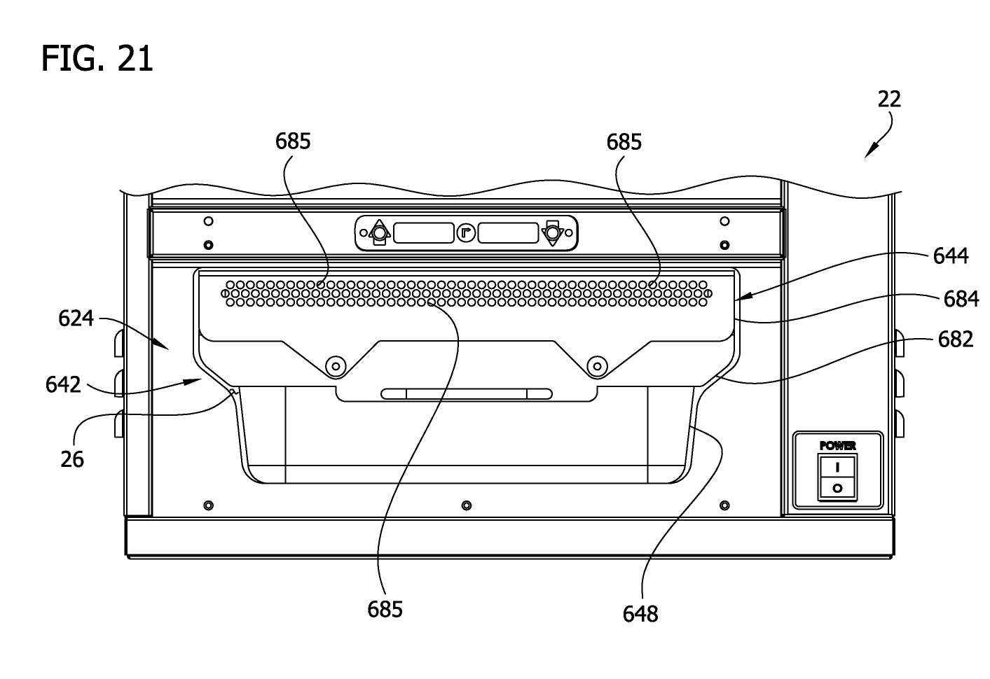

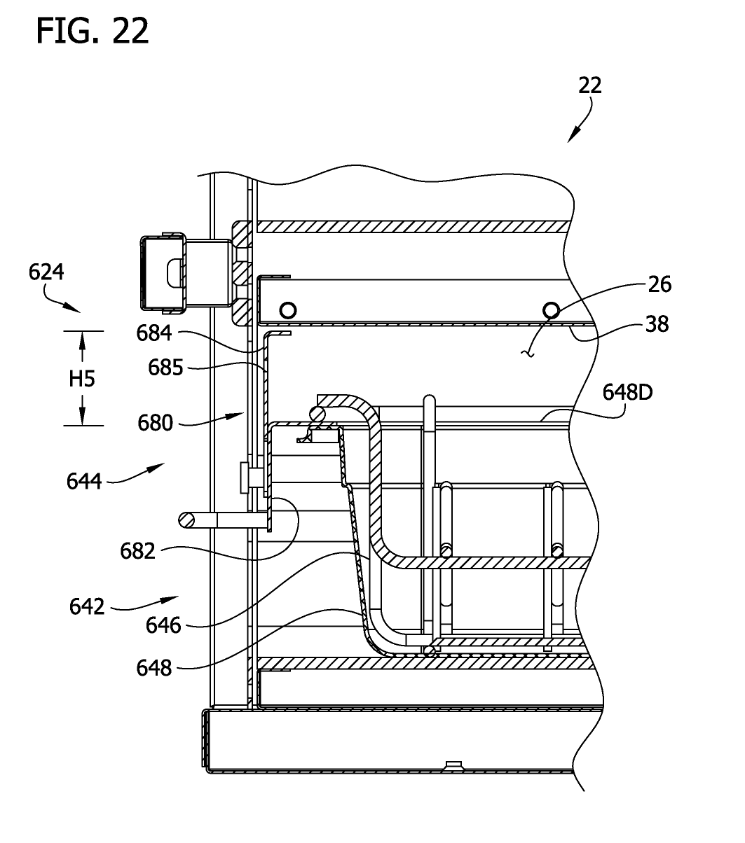

Referring to FIGS. 21 and 22, another embodiment of an apparatus of the present invention is generally indicated by the reference number 624 and shown in the lower cavity of the oven 22. The apparatus of this embodiment is similar to the apparatus 524 described above, and similar parts are indicated by corresponding reference numbers, plus 100. For example, the apparatus 624 includes a food container 642 comprising a rack 646 and a tray 648. The apparatus 624 also includes baffles 644 (only one being shown) attached to opposite ends of the food container 642. As with the baffles described above, each of the baffles 644 forms a generally upright or upstanding wall 680 for restricting flow of gas from the cavity 26 out of the open ends 30A, 32A of the cavity 26. As shown in FIGS. 21 and 22, the baffles 644 each include a base 682, which is substantially similar to the base 582 described above, and an upper member 684.

In this embodiment, the upper member 684 includes a plurality of gas flow openings 685 extending through the upper member 684 to permit gas flow through the upper member. The gas flow openings 685 are arranged in an array extending widthwise and heightwise of the upper member 684. More or fewer gas flow openings 685 or other arrangements of gas flow openings may be used without departing from the scope of the present invention. For example, upper members 684 having different numbers of openings or different arrangements of openings may be provided in a kit such that an upper member may be selected for a particular food according to the volume of gas flow it permits through its openings.

As shown in FIG. 22, the upper member 684 has a height H5 extending above the peripheral rim 648D such that the upper member extends upward across substantially all of the gap between the peripheral rim 648D and the upper wall 38 of the oven cavity 26. Baffles having other heights may be used without departing from the scope of the present invention.

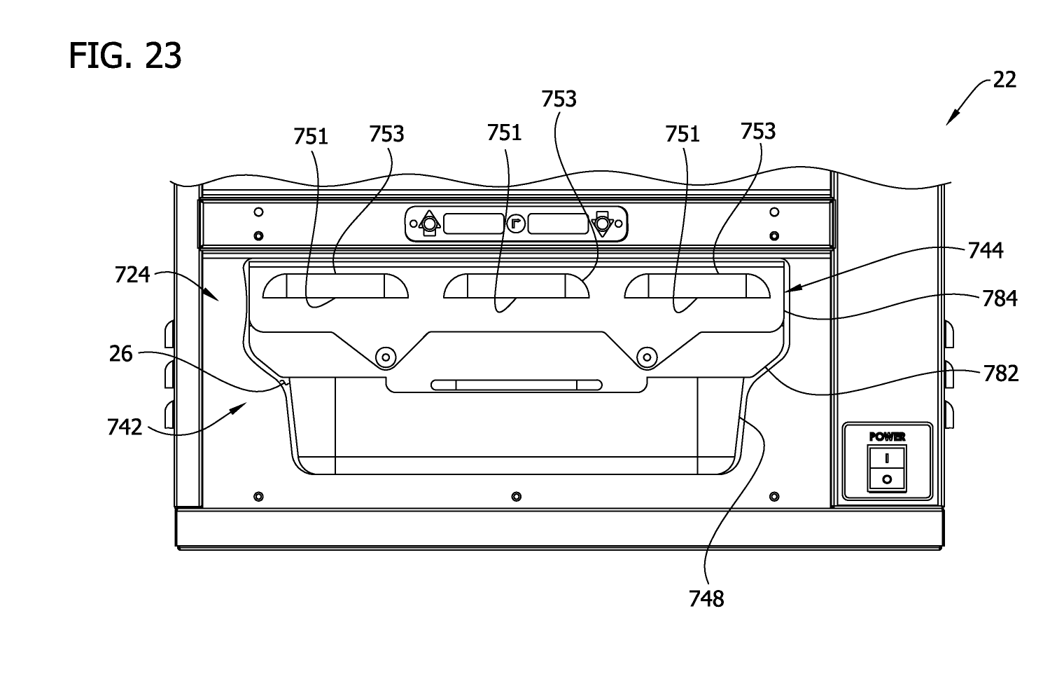

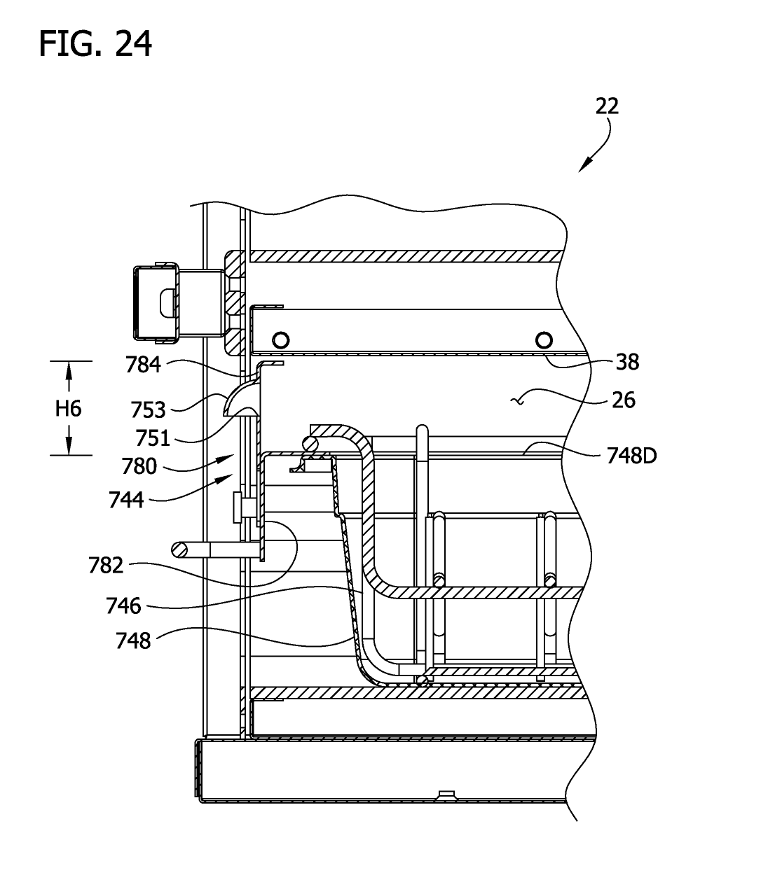

Referring to FIGS. 23 and 24, another embodiment of an apparatus of the present invention is generally indicated by the reference number 724 and shown in the lower cavity of the oven. The apparatus of this embodiment is similar to the apparatus 524 described above, and similar parts are indicated by corresponding reference numbers, plus 200. For example, the apparatus 724 includes a food container 742 comprising a rack 746 and a tray 748. The apparatus 724 also includes baffles 744 (only one being shown) attached to opposite ends of the food container 742. As with the baffles described above, each of the baffles 744 forms a generally upright or upstanding wall 780 for restricting flow of gas from the cavity 26 out of the open ends 30A, 32A of the cavity 26. As shown in FIGS. 23 and 24, the baffles 744 each include a base 782, which is substantially similar to the base 582 described above, and an upper member 784. As shown in FIG. 24, the upper member 784 has a height H6 extending above the peripheral rim 748D such that the upper member extends upward across substantially all of the gap between the peripheral rim 748D and the upper wall 38 of the oven cavity 26. Baffles having other heights may be used without departing from the scope of the present invention. In this embodiment, the upper member 784 includes a plurality of louvered gas flow openings 751 extending through the upper member 784 to permit gas flow through the upper member. The gas flow openings 751 are spaced from one another across the width of the upper member 784. Each of the gas flow openings 751 is covered at least partially by a louver 753. The louvers 753 impede gas from flowing through the openings to increase “residence time” of the gas in the oven cavity 26 above the peripheral rim 748D before it flows through the baffle 744. This may be desirable to prevent rapid evacuation of the gas from the oven cavity 26. More or fewer louvered gas flow openings 751 or other arrangements of louvered gas flow openings may be used without departing from the scope of the present invention.

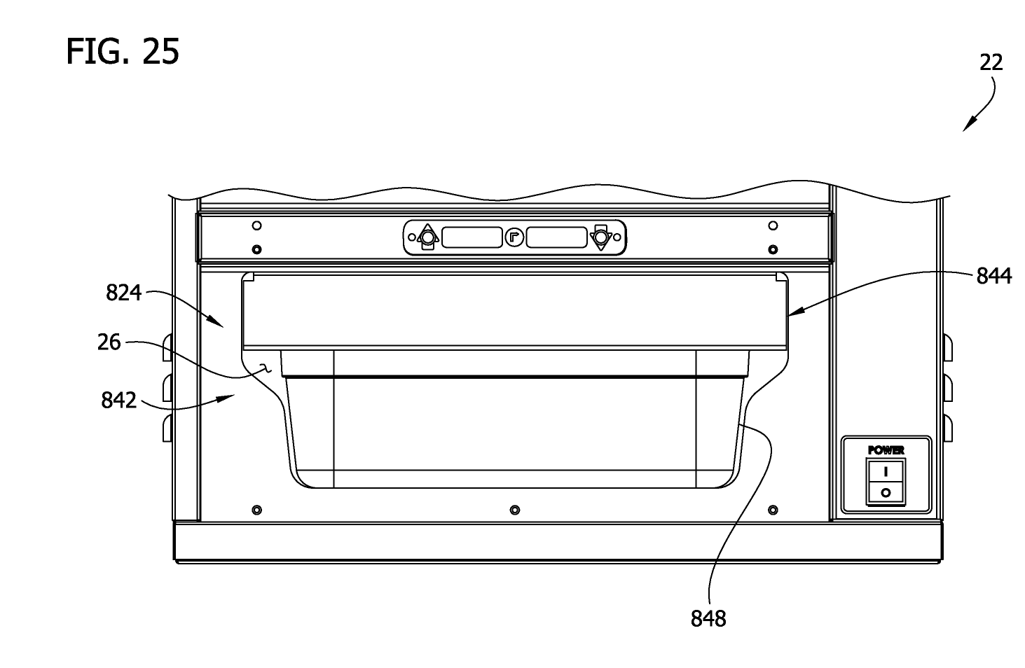

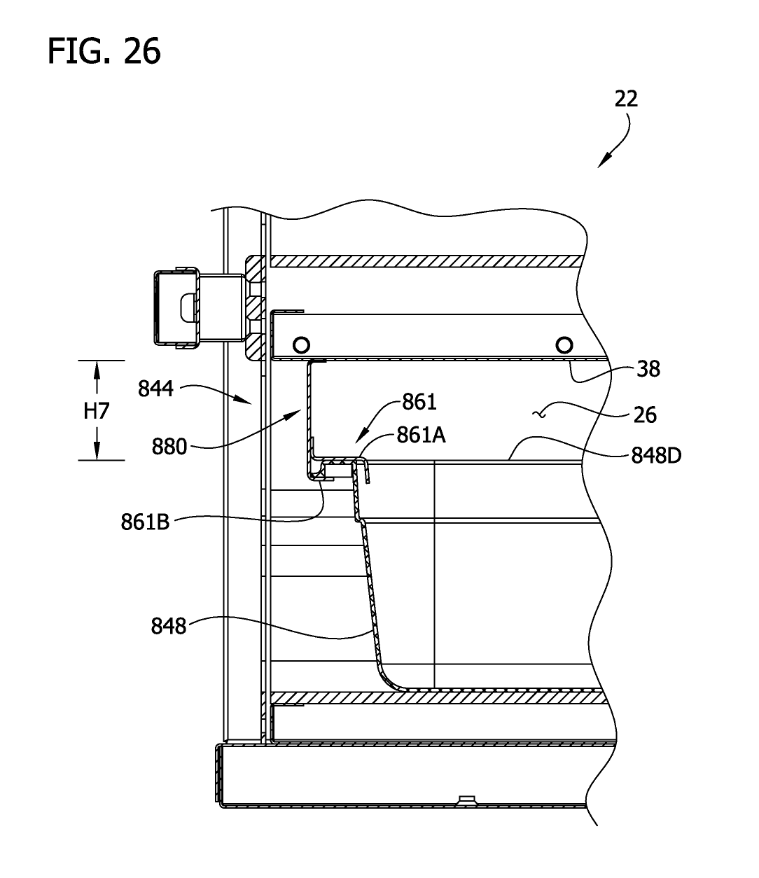

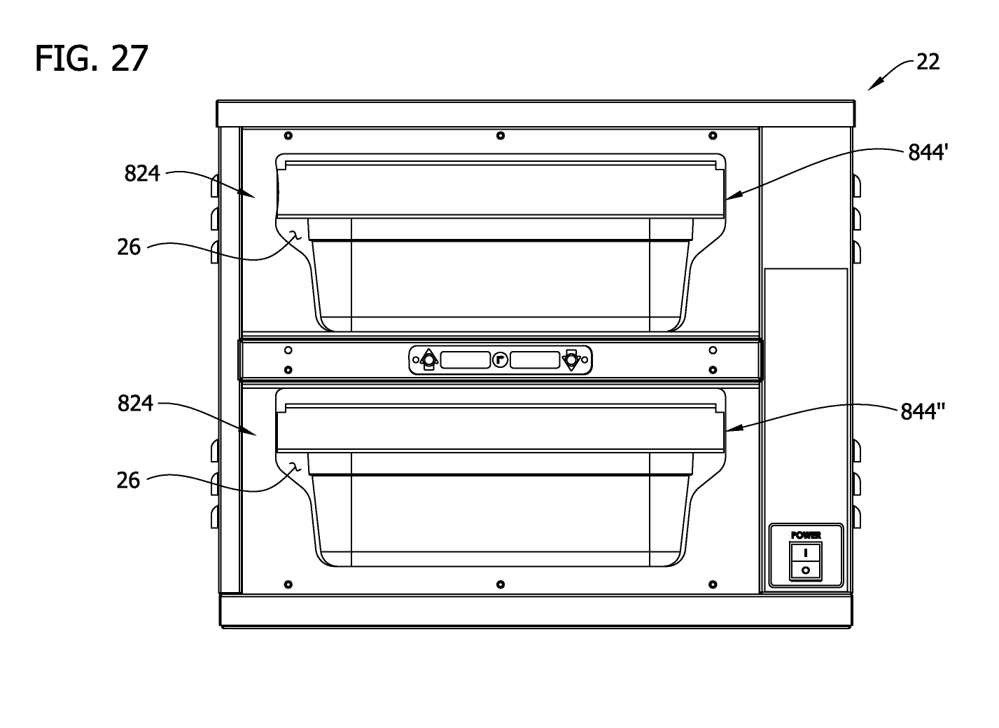

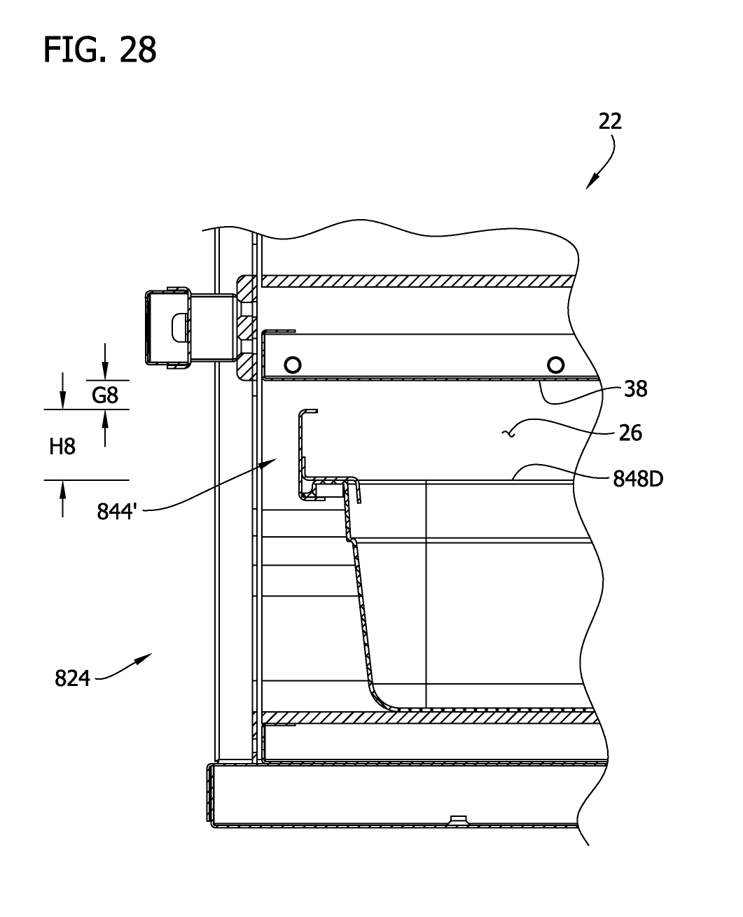

Referring to FIGS. 25 and 26, another embodiment of an apparatus of the present invention is generally indicated by the reference number 824 and shown in the lower cavity 26 of the oven 22. The apparatus 824 of this embodiment is similar to the apparatus 524 described above, and similar parts are indicated by corresponding reference numbers, plus 300. For example, the apparatus 724 includes a food container 842 comprising a tray 848. The apparatus 824 also includes baffles 844 (only one being shown) attached to opposite ends of the food container 842. As with the baffles described above, each of the baffles 844 forms a generally upright or upstanding wall 880 for restricting flow of gas from the cavity 26 out of the open ends 30A, 32A of the cavity 26. As shown in FIG. 26, in this embodiment, the baffles 844 are connected to the tray 848 instead of being connected to a rack. In this embodiment the rack is omitted, although a rack may be used without departing from the scope of the present invention. As shown in FIG. 26, the baffles 844 include a bracket 861 including arms 861A, 861B which extend above and below the peripheral rim 848D of the tray 848 to connect the baffles to the tray. This connection may be releasable for permitting the baffle 844 to be removed from the tray 848. Alternatively, the bracket 861 may be secured to the tray 848 by welding, epoxy, or another type of permanent connection. Other connections may be used without departing from the scope of the present invention. The baffles 844 have a height H7 extending above the peripheral rim 848D such that the baffle 844 extends upward across substantially all of the gap between the peripheral rim 848D and the upper wall 38 of the oven cavity 26. Moreover, as shown in FIG. 25, the baffle 844 extends across substantially all of the width of the top of the oven cavity 26. Baffles having other heights and widths may be used without departing from the scope of the present invention. For example, the two apparatus 824 shown in the upper and lower oven cavities 26 in FIG. 27 have baffles 844′, 844″ which are similar to the baffle 844 of FIGS. 25 and 26 but which have other heights for permitting different volumes of gas flow. The baffle 844′ of the apparatus 824 in the upper oven cavity 26 is shown in section in FIG. 28. The height H8 of the baffle 844′ above the peripheral rim 848D provides a relatively small gap G8 between the top of the baffle and the upper wall 38 of the cavity. Such baffles 844, 844′, 844″ may be provided as part of a kit for selective connection to different food containers.

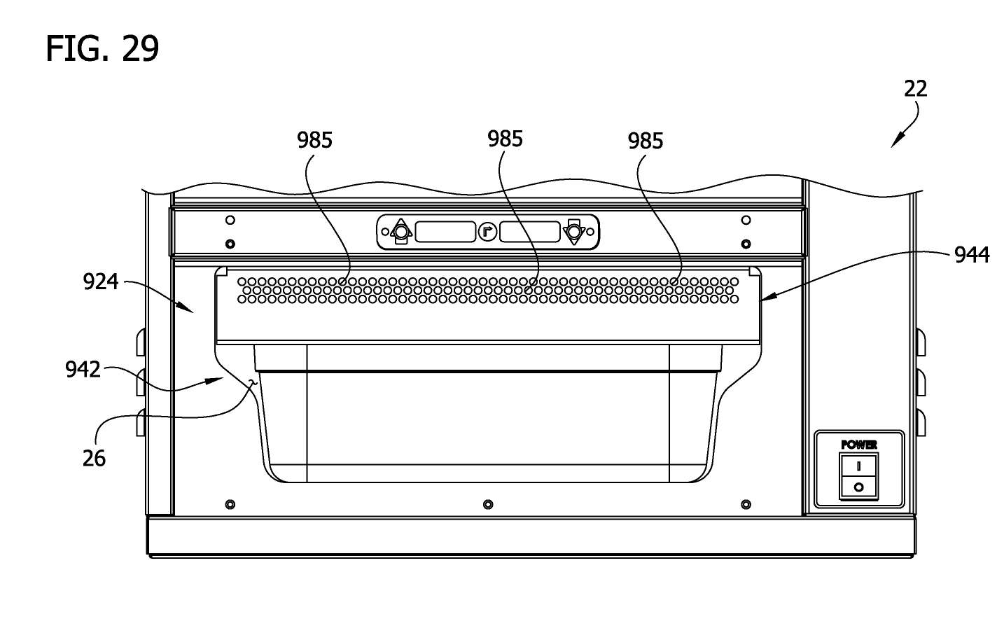

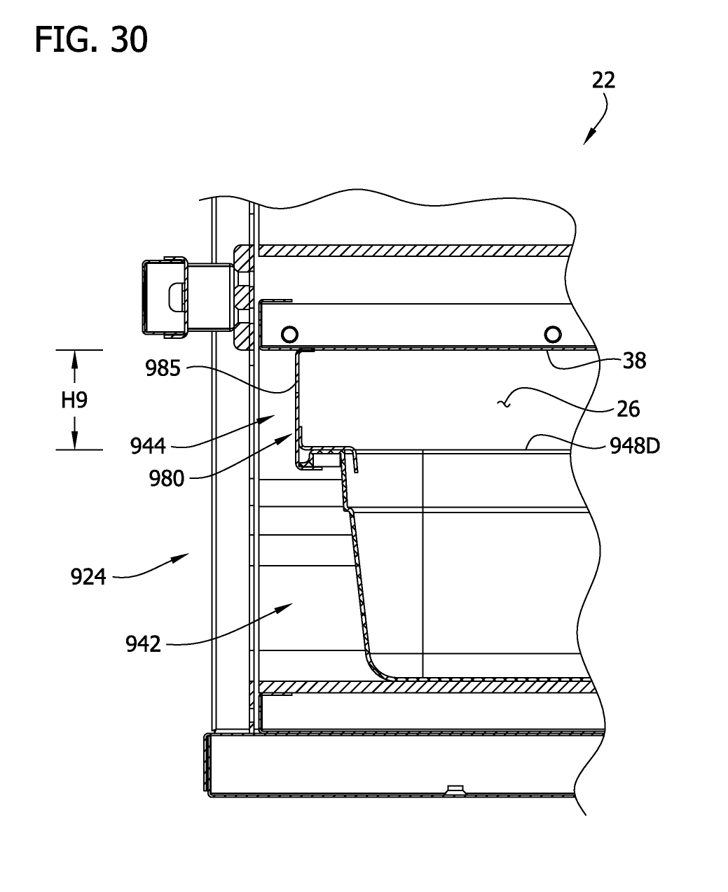

Referring to FIGS. 29 and 30, another embodiment of an apparatus of the present invention is generally indicated by the reference number 924 and shown in the lower cavity of the oven. The apparatus of this embodiment is similar to the apparatus 824 described above, and similar parts are indicated by corresponding reference numbers, plus 100. For example, the apparatus 924 includes a food container 942 having a tray 948. The apparatus 924 also includes baffles 944 (only one being shown) attached to opposite ends of the food container 942. As with the baffles described above, each of the baffles 944 forms a generally upright or upstanding wall 980 for restricting gas from flowing from the cavity 26 out of the open ends 30A, 32A of the cavity 26. The baffles 944 are connected to the tray like the baffle 844 described above. The baffles 944 have a height H9 extending across substantially all of the gap between the peripheral rim 948D and the upper wall 38 of the cavity 26. The rack is omitted, although one may be used without departing from the scope of the present invention. In this embodiment, like the embodiment illustrated in FIG. 21, gas flow openings 985 are provided in the baffle 944 for permitting gas flow through the baffle. The gas flow openings 985 are arranged in an array extending along the width and height of the baffle. Other numbers, sizes, and arrangements of gas flow openings 985 may be used without departing from the scope of the present invention.

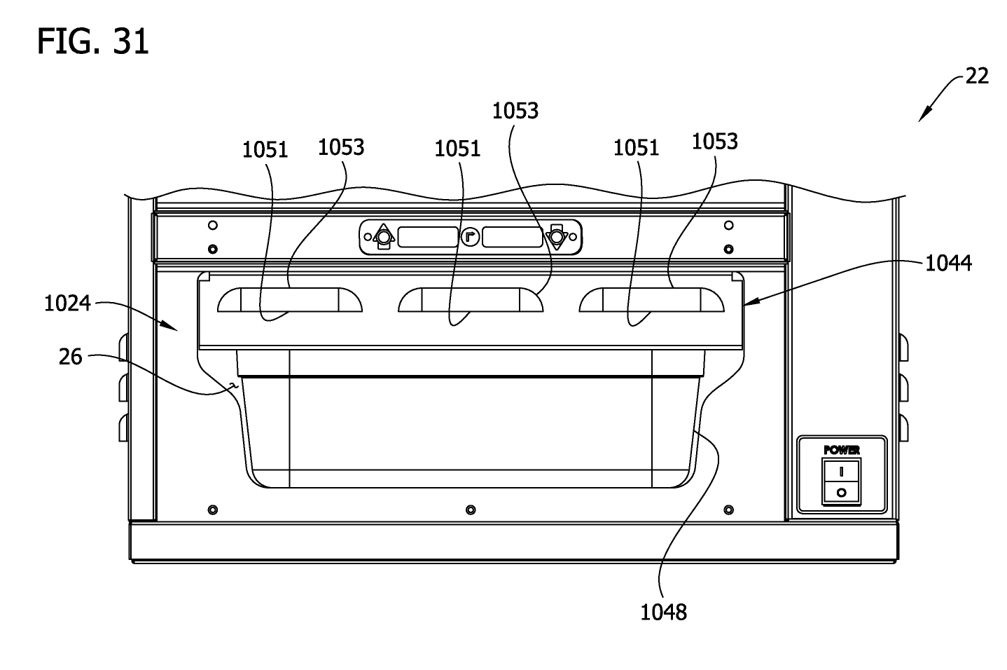

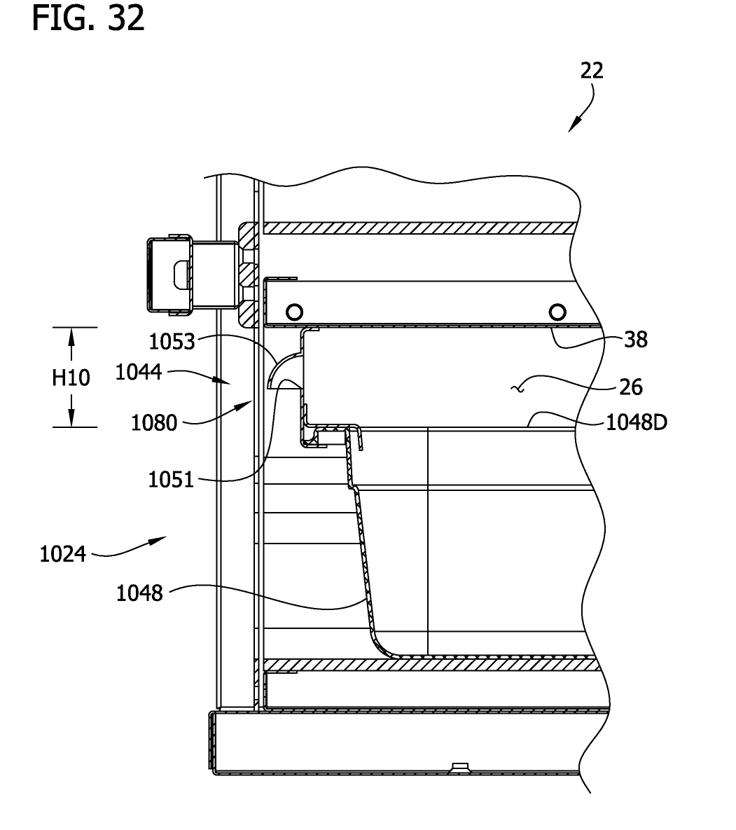

Referring to FIGS. 31 and 32, another embodiment of an apparatus of the present invention is generally indicated by the reference number 1024 and shown in the lower cavity of the oven. The apparatus of this embodiment is similar to the apparatus 824 described above, and similar parts are indicated by corresponding reference numbers, plus 200. For example, the apparatus 1024 includes a food container 1042 having a tray 1048. The apparatus 1024 also includes baffles 1044 (only one being shown) attached to opposite ends of the food container 1042. As with the baffles described above, each of the baffles 1044 forms a generally upright or upstanding wall 1080 for restricting gas from flowing from the cavity 26 out of the open ends 30A, 32A of the cavity 26. The baffles 1044 are connected to the tray 1048 like the baffle 844 described above. The baffles 1044 have a height H10 extending across substantially all of the gap between the peripheral rim 1048D and the upper wall 38 of the cavity 26. The rack is omitted, although one may be used without departing from the scope of the present invention. In this embodiment, like the embodiment illustrated in FIG. 23, louvered gas flow openings 1051 are provided in the baffle 1044 for permitting gas flow through the baffle. Each of the openings 1051 in the baffle 1044 is covered by a louver 1053 to permit but restrict gas flow though the baffle. Other numbers, sizes, and arrangements of louvered gas flow openings may be used without departing from the scope of the present invention.

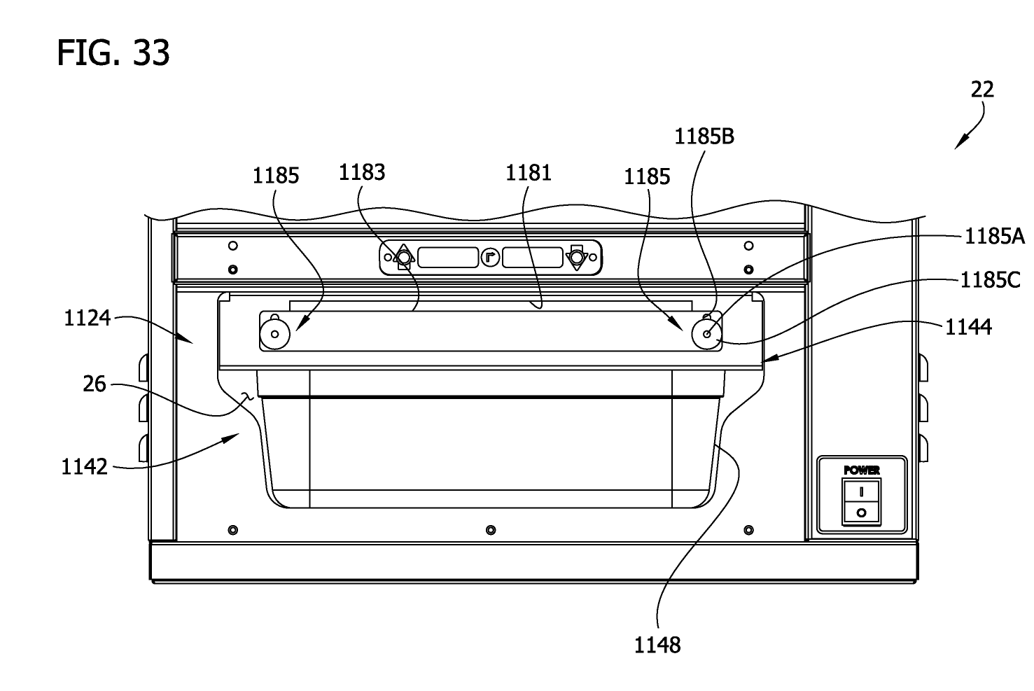

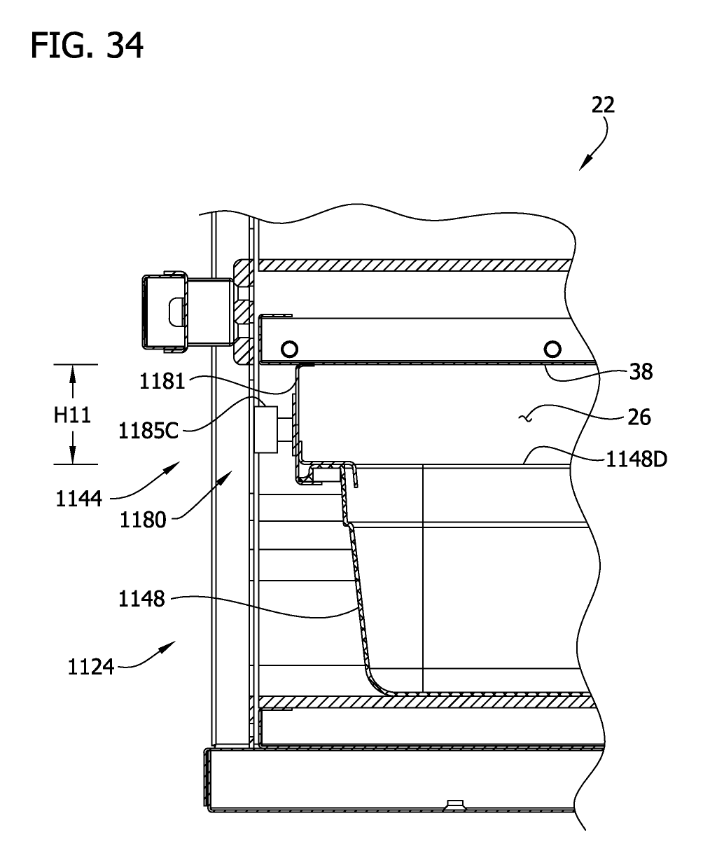

Referring to FIGS. 33 and 34, another embodiment of an apparatus of the present invention is generally indicated by the reference number 1124 and shown in the lower cavity of the oven. The apparatus of this embodiment is similar to the apparatus 824 described above, and similar parts are indicated by corresponding reference numbers, plus 300. For example, the apparatus 1124 includes a food container 1142 having a tray 1148. The apparatus 1124 also includes baffles 1144 (only one being shown) attached to opposite ends of the food container 1142. As with the baffles described above, each of the baffles 1144 forms a generally upright or upstanding wall 1180 for restricting gas from flowing from the cavity 26 out of the open ends 30A, 32A of the cavity 26. The baffles 1144 are connected to the tray 1148 like the baffle 844 described above. The baffles 1144 have a height H11 extending across substantially all of the gap between the peripheral rim 1148D and the upper wall 38 of the cavity 26. The rack is omitted, although one may be used without departing from the scope of the present invention. In this embodiment, a gas flow opening 1181 is provided in the baffle 1144 for permitting gas flow through the baffle. The baffle 1144 includes a movable member in the form of a movable plate or “slide gate” 1183 for selectively covering all or a selected portion of the gas flow opening 1181 for permitting a desired amount of gas flow through the opening. Releasable slide connections 1185 are provided for permitting selective movement of the movable member 1183. Bolts 1185A extend through elongate slots 1185B in opposite sides of the movable member 1183, and nuts 1185C on the bolts are movable between “tightened” and “loosened” positions to secure the movable member in position and permit movement of the movable member, respectively. In FIGS. 33 and 34, the movable member 1183 is shown in a partially raised position for partially covering the gas flow opening. The movable member 1183 may be lowered to completely uncover the gas flow opening 1181 or be moved upward cover a selected portion of the gas flow opening or the entire gas flow opening. Other types and configurations gas flow openings and movable members may be used without departing from the scope of the present invention.

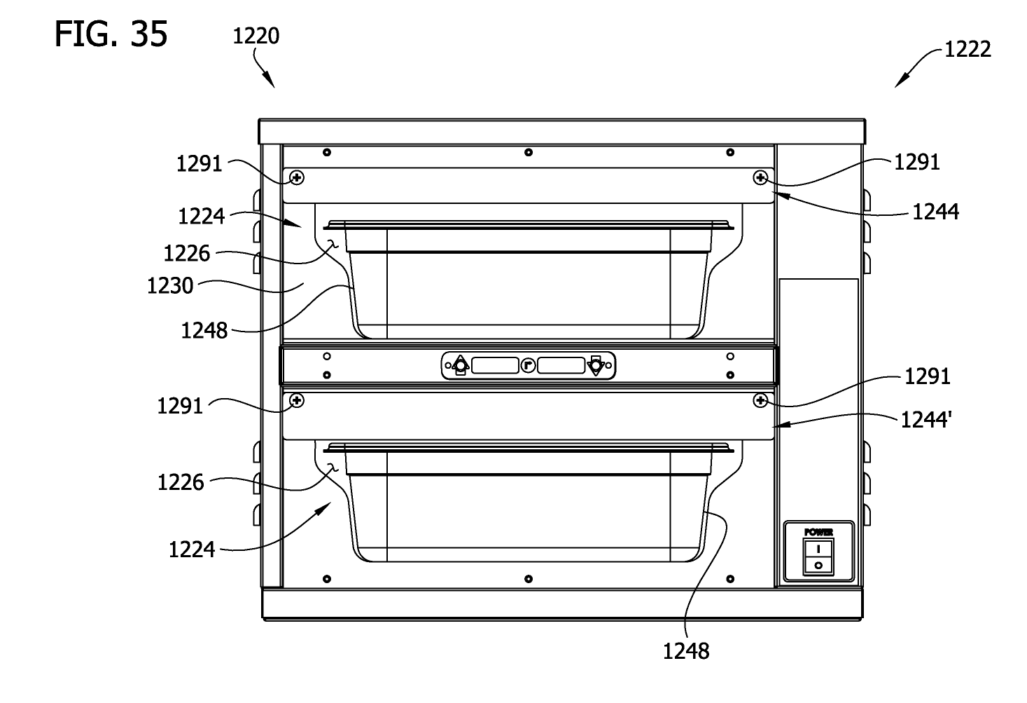

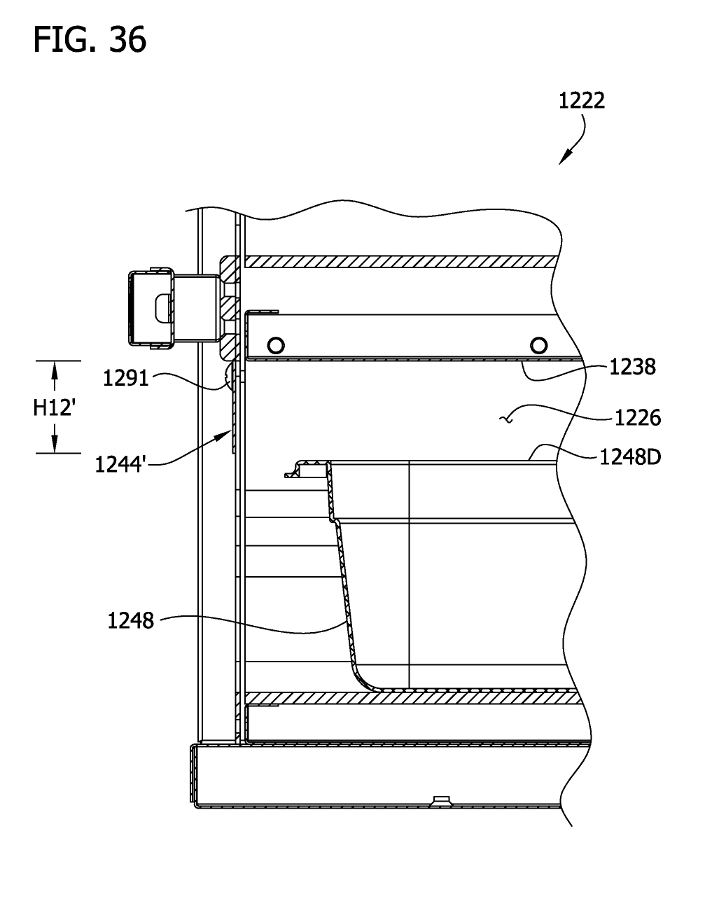

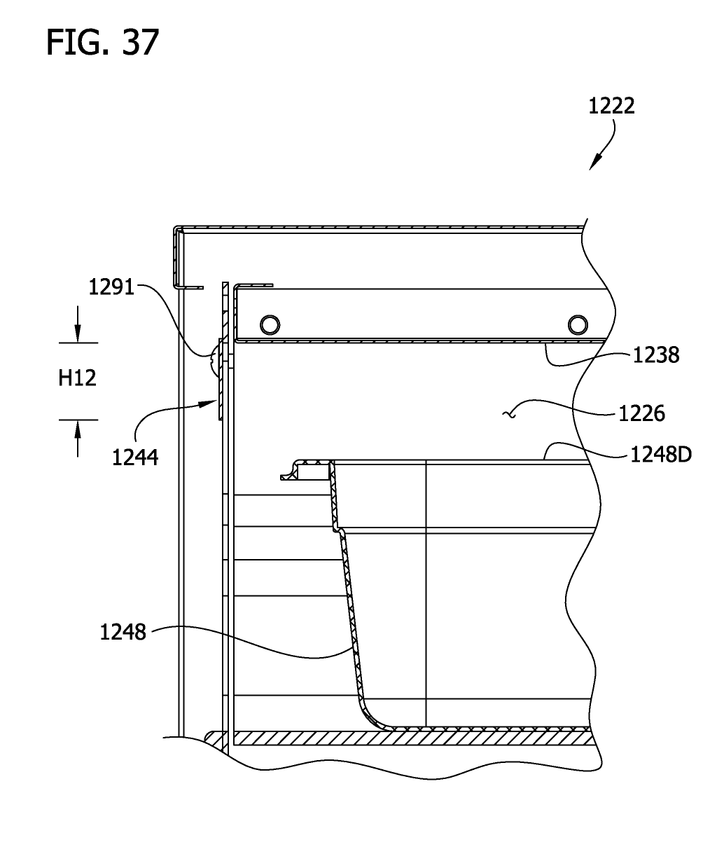

Referring to FIGS. 35-37, another embodiment of a system of the present invention is shown and generally indicated by the reference number 1220. The illustrated apparatus 1224 includes a tray 1248 without a rack. Other apparatus, such as including a rack, may be used without departing from the scope of the present invention. In this embodiment, the baffles 1244, 1244′ are provided on the oven 1222 instead of on the apparatus 1224. The baffles 1244, 1244′ are shown in the form of generally flat rectangular plates which extend across the top of the oven cavities 1226. The baffles 1244, 1244′ are releasably connected to the front of the oven 1222 (i.e., the front panel 1230) by fasteners (e.g., screws) 1291 against opposite ends of the baffles. Each baffle 1244, 1244′ has a height which extends at least from the upper wall 1238 of the oven cavity 1226 to a position below the upper wall 1238 of the oven cavity toward the peripheral rim 1248D. The baffle 1244 for the upper oven cavity 1226 has a shorter height than the baffle 1244′ for the lower oven cavity 1226. Accordingly, the baffle 1244′ for the lower oven cavity 1226 restricts gas flow more than the baffle 1244 for the upper oven cavity 1226. As shown in FIG. 37, the baffle 1244 of the upper oven cavity 1226 has a height H12 which leaves a gap between the peripheral rim 1248D of the tray 1248 and the bottom of the baffle. On the other hand, as shown in FIG. 36, the baffle 1244′ of the lower oven cavity 1226 has a height H12 which extends downward from the upper wall 1238 of the oven cavity 1226 to about the same height as the peripheral rim 1248D. The baffles 1244, 1244′ may be provided as part of a kit such that a baffle having a desired height may be selectively connected to the oven using suitable fasteners.

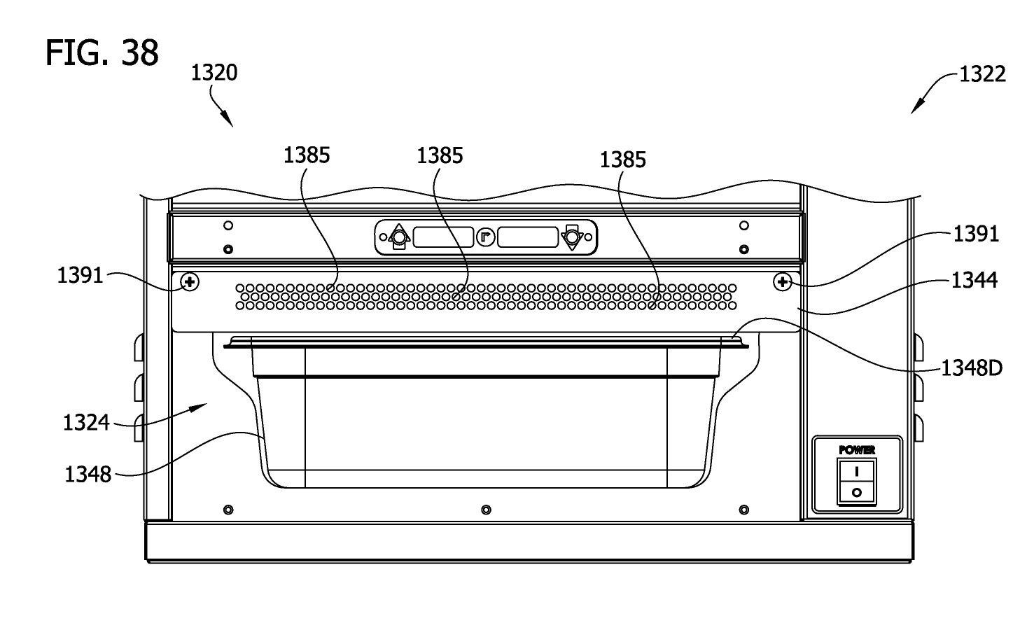

Referring to FIG. 38, another embodiment of a system of the present invention is shown and generally indicated by the reference number 1320. The illustrated apparatus 1324 includes a tray 1348 without a rack. Other apparatus, such as including a rack, may be used without departing from the scope of the present invention. Like the embodiment of the system 1220 described above, in this embodiment, the baffles 1344 are provided on the oven 1322 instead of on the apparatus 1324. The baffles 1344 are shown in the form of generally flat rectangular plates which extend across the top of the oven cavities 1326 and are releasably connected to the front of the oven 1322 by fasteners (e.g., screws) 1391. The baffle 1344 has a height which extends downward to about the same height as the peripheral rim 1348D. In this embodiment, the baffle 1344 includes an array of gas flow openings 1385, like the embodiments illustrated in FIGS. 21 and 29. The gas flow openings 1385 are provided above the peripheral rim 1348D of the tray for permitting gas to flow from the top of the oven cavity 1326 above the peripheral rim 1348D of the tray to outside the oven cavity 1326 through the baffle 1344. Other numbers, sizes, and arrangements of gas flow openings 1385 may be used without departing from the scope of the present invention.

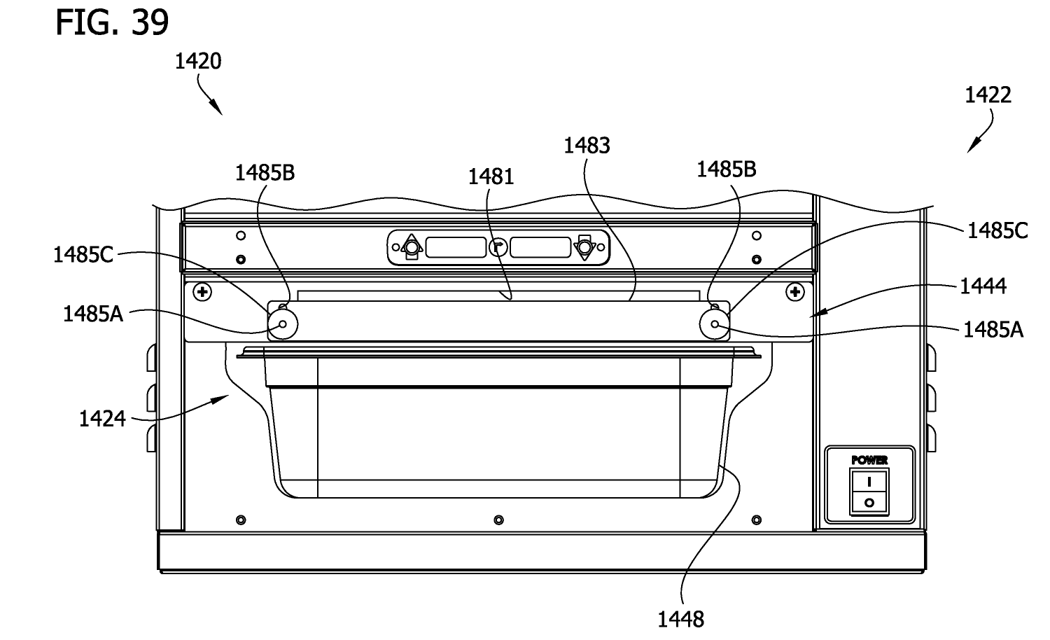

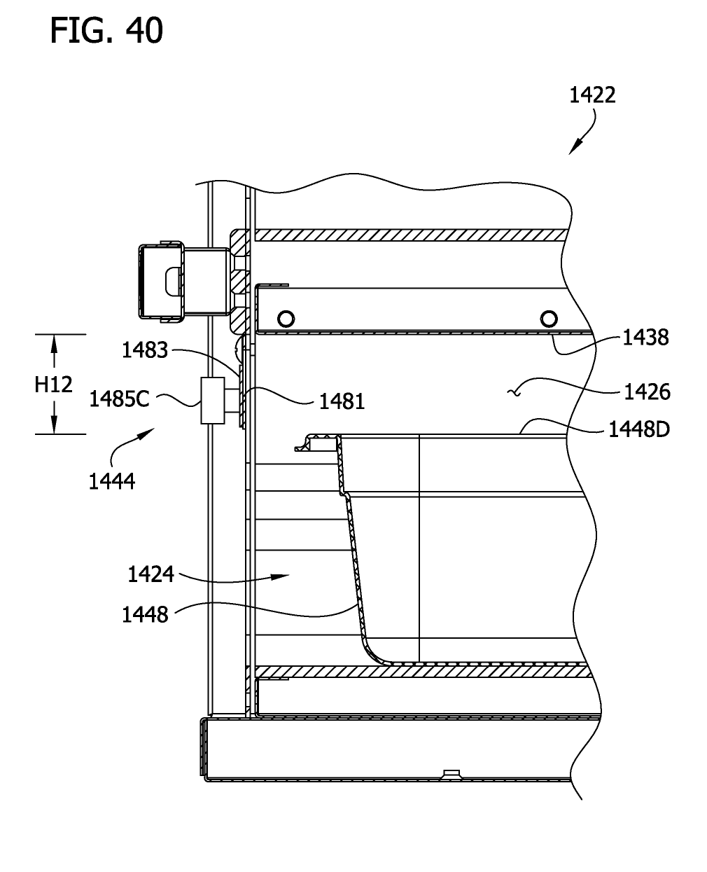

Referring to FIGS. 39 and 40, another embodiment of a system of the present invention is shown and generally indicated by the reference number 1420. The illustrated apparatus 1424 includes a tray 1448 without a rack. Other apparatus, such as including a rack, may be used without departing from the scope of the present invention. Like the embodiment of the system 1220 described above, in this embodiment, the baffles 1444 are provided on the oven 1422 instead of on the apparatus 1424. As shown in FIG. 40, the baffle 1444 has a height H12 which extends downward from the upper wall 1438 of the oven cavity 1426 to about the same height as the peripheral rim 1448D. In this embodiment, the baffle 1444 includes a movable member 1483 provided in the form of a plate or “slide gate” which is movable to selectively cover a flow opening 1481 in the baffle, similar to the baffle 1144 illustrated in FIG. 33. Bolts 1485A extend through elongate slots 1485B in opposite sides of the movable member 1481, and nuts 1485C on the bolts are movable between “tightened” and “loosened” positions to secure the movable member in position and permit movement of the movable member, respectively. As in FIGS. 33 and 34, the movable member 1483 is shown in a partially raised position for partially covering the gas flow opening 1481. The movable member 1483 may be lowered to completely uncover the gas flow opening 1481 or be moved upward to completely cover the gas flow opening or cover any selected portion of the flow opening. Other types and configurations gas flow openings and movable members may be used without departing from the scope of the present invention.

Although the baffles disclosed herein are discussed as being provided on opposite ends of an apparatus or opposite ends of an oven cavity (e.g., for a pass-through oven), it will be understood that a baffle may be provided on only one end of the apparatus or one side of the oven. For example, if the oven includes only one open end, the apparatus for use with that oven may have a baffle on only one of its ends, or the oven may have only one baffle associated with the open end.

Desirably, the baffles disclosed herein have a width which extends across substantially all of or is not substantially less than the width of the open ends of the oven cavities. However, baffles having other widths may be used without departing from the scope of the present invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, items, and methods without departing from the scope of the invention, it is intended that all matter contained in the above description and shown in the accompanying drawing[s] shall be interpreted as illustrative and not in a limiting sense.

What is claimed is:

1. Apparatus configured for holding at least one food item and being inserted in a cavity of an oven, the oven cavity being bounded by at least a bottom wall, opposite side walls, and an upper wall, the cavity having opposite first and second ends at least one of which is open for receiving the apparatus in the oven cavity, the apparatus comprising:
a food container having a bottom wall, opposite side walls, opposite first and second end walls, a peripheral rim, and an open top, the food container being sized and shaped for receiving the at least one food item; and
a baffle attached to the food container, the baffle being smaller than said at least one open end of the oven cavity, the baffle being positioned adjacent to one of the first and second end walls of the food container and extending above the peripheral rim of the food container for restricting gas flow out of the open end of the oven cavity along a flow path between the peripheral rim and the upper wall of the oven cavity when the food container is in the oven cavity.

2. The apparatus of claim 1 wherein the baffle includes an upstanding wall.

3. The apparatus of claim 1 wherein the baffle is positioned adjacent to the first end wall and extends a height above the peripheral rim.

4. The apparatus of claim 2 wherein the baffle is adjustable for permitting adjustable restriction of the gas flow along said flow path.

5. The apparatus of claim 4 wherein the baffle includes a movable member, the movable member being movable between at least first and second positions, the movable member in the first position restricting gas flow out of the open end of the oven cavity along said flow path more than when the movable member is in the second position.

6. The apparatus of claim 5 wherein the baffle includes at least one securing member for securing the movable member in the at least first and second positions, the securing member having a securing position in which the securing member prevents movement of the movable member, and the securing member being movable from the securing position for permitting movement of the movable member between the first and second positions.

7. The apparatus of claim 5 wherein the movable member is movable upward and downward for adjusting the height to which the movable member extends above the peripheral rim.

8. The apparatus of claim 5 wherein the baffle includes an opening for permitting gas flow through the baffle out of the open end of the oven cavity between the peripheral rim and the upper wall of the oven cavity, the movable member being movable to at least partially cover the opening to restrict gas flow through the opening.

9. The apparatus of claim 3 wherein the baffle includes at least one gas flow opening extending through the baffle for permitting gas flow through the baffle out of the open end of the oven cavity along said flow path.

10. The apparatus of claim 9 wherein said gas flow opening is at least partially covered by a louver.

11. The apparatus of claim 9 wherein said at least one gas flow opening is one of a plurality of openings spaced in an array extending widthwise along the baffle.

12. The apparatus of claim 1 wherein the baffle is a first baffle positioned adjacent the first end of the food container, the apparatus further including a second baffle positioned adjacent the second end of the food container.

13. The apparatus of claim 1 wherein the food container includes a rack for holding the plurality of food items, and wherein the baffle is attached to the rack.

14. The apparatus of claim 13 wherein the food container includes a tray defining the bottom, side, and end walls and peripheral rim of the food container, the tray including a compartment above the bottom wall and between the side and end walls, the rack being receivable in the compartment of the tray for supporting the at least one food item in the compartment and at least partially below the peripheral rim.

15. The apparatus of claim 1 wherein the food container includes a tray and the baffle is attached to the tray.

16. An oven for holding at least one food item, the oven including:
an oven cavity sized and shaped for holding the at least one food item, the cavity having a bottom bounded by a bottom wall, opposite sides bounded by side walls, and a top bounded by an upper wall, the cavity having opposite first and second ends at least one of which is open; and
a baffle positioned adjacent the top of the cavity at the open end of the cavity, the baffle extending downward from the upper wall to a position below the upper wall for restricting gas flow out of the open end of the oven cavity at the top of the oven cavity, the baffle including a gas flow opening for permitting gas to flow from the top of the oven cavity through the gas flow opening to outside the oven cavity.

17. An oven as set forth in claim 16 wherein the baffle is adjustable for adjusting a flow area of the gas flow opening through which gas is permitted to flow.

18. An oven as set forth in claim 17 wherein the baffle includes a movable member, the movable member being movable between at least first and second positions, the movable member in the first position providing the opening with a smaller flow area than when the movable member is in the second position.

19. A system for holding at least one food item, the system including:
an oven including an oven cavity, the cavity having a bottom bounded by a bottom wall, opposite sides bounded by side walls, and a top bounded by an upper wall, the cavity having opposite first and second ends at least one of which is open;
a food container having a bottom wall, opposite side walls, opposite first and second end walls, a peripheral rim, and an open top, the food container being sized and shaped for receiving the at least one food item; and
a kit including first and second baffles each adapted for releasable connection to at least one of the oven and the food container for restricting gas flow out of the oven cavity, each of the first and second baffles when connected to the at least one of the oven and food container being positioned for restricting gas from flowing from the oven cavity through a gap between the peripheral rim of the food container and the upper wall of the oven cavity to outside the oven cavity, the second baffle being configured for permitting more gas flow through the gap than the first baffle, the first and second baffles being selectively connectable to the at least one of the oven and the food container for restricting gas flow through the gap according to the configuration of the selected baffle.

20. A system as set forth in claim 19 wherein each of the first and second baffles when connected to the at least one of the oven and food container has a height sufficient to at least partially close the gap between the peripheral rim of the food container and the upper wall of the oven cavity, and the height of the first baffle is greater than the height of the second baffle.
